(19) United States
(12) Patent Application Publication
(10) Pub. No.: US 2026/0191714 A1
(43) Pub. Date: Jul. 9, 2026

(54) DIMENSIONALLY-BASED APPROACHES FOR CONSTRUCTING AND OPERATING PRESSURE-MITIGATION APPARATUSES

(71) Applicant: TurnCare, Inc., Palo Alto, CA (US)

(72) Inventors: Rafael Paolo Squitieri, Wilton, CT (US); Steven Bruce Frazier, Sloatsburg, NY (US); Robert Charles Deutsch, Oakridge, CA (US); Yun Yi, Tenafly, NJ (US)

(21) Appl. No.: 19/551,377

(22) Filed: Feb. 26, 2026

Related U.S. Application Data
(63) Continuation of application No. PCT/US2024/044679, filed on Aug. 30, 2024.
(60) Provisional application No. 63/579,840, filed on Aug. 31, 2023.

(51) Int. Cl. A61G 7/057

(52) U.S. Cl. CPC A61G 7/05784; A61G 7/05776; A61G 2203/32

(57) ABSTRACT

Disclosed devices for pressure mitigation include dynamic therapy through inflation/deflation of chambers over time, while minimizing bunching or wrinkling of deflated material. The chambers are formed (e.g., via interconnections, sidewalls) in a deflated state of the device, in which the device is in a substantially two-dimensional form. When inflated, the chambers are expanded from their default two-dimensional or compact state to an enlarged three-dimensional or expanded state. Thus, when deflated, the chambers return to their original form, leaving no excess material that may bunch or wrinkle.

### CROSS-REFERENCE TO RELATED APPLICATIONS

This application is a continuation of International Application No. PCT/US2024/044679, titled “Dimensionally-Based Approaches for Constructing and Operating Pressure-Mitigation Apparatuses” and filed on August 30, 2024, which claims priority to US Provisional Application No. 63/579,840, titled “Dimensionally-Based Approaches for Constructing and Operating Pressure-Mitigation Apparatuses” and filed on August 31, 2023, each of which is incorporated by reference herein in its entirety.

### TECHNICAL FIELD

Various embodiments concern pressure-mitigation apparatuses able to alleviate pressure applied on a body, such as a human body.

### BACKGROUND

Pressure injuries - sometimes referred to as "decubitus ulcers," "pressure ulcers," "pressure sores," or "bedsores" - may occur as a result of steady pressure being applied in one location along the surface of the human body for a prolonged period of time. Regions with bony prominences are especially susceptible to pressure injuries. Pressure injuries are most common in individuals who are completely immobilized (e.g., on an operating table, bed, or chair) or have impaired mobility. These individuals may be older, malnourished, or incontinent, all factors that predispose the human body to formation of pressure injuries.

These individuals are often not ambulatory, so they sit or lie for prolonged periods of time in the same position. Moreover, these individuals may be unable to reposition themselves to alleviate pressure. Consequently, pressure on the skin and underlying soft tissue may eventually result in inadequate blood flow to the area, a condition referred to as “ischemia,” thereby resulting in damage to the skin or underlying soft tissue. Pressure injuries can take the form of a superficial injury to the skin or a deeper ulcer that exposes the underlying tissues and places the individual at risk for infection. The resulting infection may worsen, leading to sepsis or even death in some cases.

There are various technologies on the market that profess to prevent pressure injuries. However, these conventional technologies have many deficiencies. For instance, these conventional technologies are unable to control the spatial relationship between a human body and a support surface (or simply “surface”) that applies pressure to the human body. Conventional technologies are also unable to effectively coordinate the use of multiple surfaces that apply pressure to various parts of the human body. Consequently, individuals that use these conventional technologies have to operate multiple devices that control multiple surfaces, with the outcome being that they may still develop pressure injuries or suffer from related complications.

### BRIEF DESCRIPTION OF THE DRAWINGS

FIGS. 1A-1B are top and bottom views, respectively, of a pressure-mitigation device able to relieve the pressure on an anatomical region applied by the surface of an elongated object in accordance with embodiments of the present technology.

FIGS. 2A and 2B are top and bottom views, respectively, of a pressure-mitigation device configured in accordance with embodiments of the present technology.

FIG. 3 is a top view of a pressure-mitigation device for relieving pressure on an anatomical region applied by an elongated object in accordance with embodiments of the present technology.

FIG. 4 is a partially schematic top view of a pressure-mitigation device illustrating how a pressure gradient can be created by varying pressure distributions to avoid ischemia in a mobility-impaired patient in accordance with embodiments of the present technology.

FIG. 5A is a partially schematic side view of a pressure-mitigation device for relieving pressure on a specific anatomical region by deflating one or more chambers in accordance with embodiments of the present technology.

FIG. 5B is a partially schematic side view of a pressure-mitigation device for relieving pressure on a specific anatomical region by inflating one or more chambers in accordance with embodiments of the present technology.

FIGS. 6A-6D are diagrams illustrating two-dimensional construction of example pressure-mitigation devices for at least minimization of excess material and patient stabilization.

FIGS. 7A-7B demonstrate two-dimensional construction of an example pressure-mitigation device based on collected user data of pressure or force distributions.

FIG. 8 is a top view of an example pressure-mitigation device that is constructed via two-dimensional side profiles.

FIG. 9 is a flow diagram that illustrates example operations for a two-dimensional construction of a pressure-mitigation device.

FIGS. 10A and 10B are diagrams that illustrate example pressure-mitigation devices configured to statically maintain a user within a flat plane during chamber inflation and deflation.

FIG. 11 is a flow diagram that illustrates example operations for configuring a pressure-mitigation device to statically maintain a user within a flat plane during chamber inflation and deflation.

FIGS. 12A-12C are isometric, front, and back views, respectively, of a controller device (also referred to as a “controller”) that is configured for controlling inflation and/or deflation of one or more independent chamber devices and/or chambers of a pressure-mitigation device in accordance with embodiments of the present technology.

FIG. 13 illustrates an example of a controller in accordance with embodiments of the present technology.

FIG. 14 is a block diagram illustrating an example of a processing system in which at least some operations described herein can be implemented.

Various features of the technologies described herein will become more apparent to those skilled in the art from a study of the Detailed Description in conjunction with the drawings. Embodiments are illustrated by way of example and not limitation in the drawings. While the drawings depict various embodiments for the purpose of illustration, those skilled in the art will recognize that alternative embodiments may be employed without departing from the principles of the technologies. Accordingly, while specific embodiments are shown in the drawings, the technology is amenable to various modifications.

### DETAILED DESCRIPTION

The term “pressure injury” refers to a localized region of damage to the skin and/or underlying tissue that results from contact pressure (or simply “pressure”) on the corresponding anatomical region of the human body. Pressure injuries will often form over bony prominences, such as the skin and soft tissue overlying the sacrum, coccyx, heels, or hips. However, other sites may also be affected. For instance, pressure injuries may form on the elbows, knees, ankles, shoulders, abdomen, back, or cranium. Pressure injuries may develop when pressure is applied to the blood vessels in soft tissue in such a manner that blood flow to the soft tissue is at least partially obstructed (e.g., due to the pressure exceeding the capillary filling pressure), and ischemia results at the site when such obstruction occurs for an extended duration. Accordingly, pressure injuries are normally observed on individuals who are mobility impaired, immobilized, or sedentary for prolonged periods of time.

Once pressure injuries have formed, the healing process is normally slow. When pressure is relieved from the site of a pressure injury, the body will rush blood (with proinflammatory mediators) to that region to perfuse the area with blood. The sudden reperfusion of the damaged (and previously ischemic) region has been shown to cause an inflammatory response, brought on by the proinflammatory mediators, that can actually worsen the pressure injury (and thus prolong recovery). Moreover, in some cases, the proinflammatory mediators may spread through the bloodstream beyond the site of the pressure injury to cause a systemic inflammatory response (also referred to as a “secondary inflammatory response”). Secondary inflammatory responses caused by proinflammatory mediators have been shown to exacerbate existing conditions and/or trigger new conditions, thereby slowing recovery. Recovery can also be prolonged by factors that are frequently associated with individuals who are prone to pressure injuries, such as old age, immobility, preexisting medical conditions (e.g., arteriosclerosis, diabetes, or infection), smoking, and medications (e.g., anti-inflammatory drugs). Inhibiting the formation of pressure injuries (and reducing the prevalence of proinflammatory mediators) can enhance and expedite many treatment processes, especially for those individuals whose mobility is impaired during treatment.

Introduced here, therefore, are pressure-mitigation devices able to mitigate the pressure applied to a human body by the surface of an object (also referred to as a “structure”). A controller device (or simply “controller”) can be fluidically coupled to a pressure-mitigation device (also referred to as a “pressure-mitigation apparatus” or a “pressure-mitigation pad”) that includes a series of selectively inflatable chambers (also referred to as “cells” or “compartments”). When a pressure-mitigation device is placed between a human body and a surface, the controller can continuously, intelligently, and autonomously circulate fluid through the chambers of the pressure-mitigation device. Normally, the controller circulates air through the chambers of the pressure-mitigation device, though the controller could circulate another fluid, such as water or gel, through the chambers of the pressure-mitigation device. As further discussed below, the controller may cause the chambers to be selectively inflated, deflated, or any combination thereof.

Also introduced here are dimensionally-based approaches to constructing pressure-mitigation devices. As further discussed below, pressure-mitigation devices can comprise material that forms the chambers and that enables the inflation and deflation of the chambers, for example, to alleviate pressure applied to a human body by the surface of an object. The material can be characterized with some elasticity in some embodiments. Generally, a pressure-mitigation device is constructed to minimize or avoid bunching of excess material when its chambers are in a deflated state. Such a design, namely, where the pressure-mitigation device is substantially planar when its chambers are in the deflated state, not only makes deployment on the surface of the object easier, but lessens the likelihood of unintentional irritation (e.g., due to bunching or wrinkling of material that can rub against the skin) when the pressure-mitigation is not being operated. As such, a pressure-mitigation device can provide dynamic therapy (e.g., inflation and deflation of chambers over time) to an individual disposed atop the pressure-mitigation device while minimizing artificial or introduced pressure points presented by material bunching or wrinkling that may occur during the dynamic inflation and deflation of the chambers.

In particular, a pressure-mitigation device can be designed and constructed using an initial two-dimensional (2D) approach or construction, from which the pressure-mitigation device is then inflatable to a three-dimensional (3D) form. A flat, substantially planar, or 2D deflated state of the pressure-mitigation device is materialized first with a minimal amount of material. By minimally materializing the deflated state of an inflatable pressure-mitigation device first, as opposed to starting from a deflatable pressure-mitigation device, the challenge of excess bunching or wrinkling of material in the device’s smallest form (e.g., its deflated state) is avoided.

While a pressure-mitigation device is initially designed and constructed in its flat, deflated form, the desired characteristics and properties of the pressure-mitigation device in its prospective inflated 3D form need to be accounted for. Desired, and configurable 3D inflated properties of the pressure-mitigation device includes inflated heights of the chambers, and/or a height profile across multiple profiles. Chamber widths within the 2D form can be determined and optimized in order to achieve the desired 3D form. For example, a bowl-shaped profile is desired for the inflated 3D form of the device (e.g., in order to retain and center an individual atop the device), and chamber widths for individual chambers can be defined while in the flat 2D form to achieve and realize the bowl-shaped profile. In some examples, 3D profiles are determined based on pressure maps that describes pressures or forces distributed across dimensions of the pressure-mitigation device by an individual (or cohorts of individuals) resting atop the pressure-mitigation device. These specific 3D profiles can also be achieved based on optimizing “precursor-ing” properties in the flat 2D form of the device.

Inflated chamber heights are one example of 3D properties/features that can be precursor-ed and realized from the initial 2D construction of a pressure-mitigation device. Another 3D property/feature of the pressure-mitigation device includes the design and placement of voids between inflated chambers. Such voids provide microclimates underneath an individual resting atop the chambers of the pressure-mitigation device, which improves physiological health at least of the individual’s surface skin. Voids can be specifically located and sized throughout the pressure-mitigation device through the specific design and optimization of the two-dimensional construction of the pressure-mitigation device. A void that exists in the space vacated when a chamber is deflated can be sized and configured based on the size of the chamber (e.g., a wider chamber when deflated leaves a wider void). In some examples, voids also exist between adjacent chambers. When inflated from a 2D construction, the chambers may not be perfectly prismatic in three-dimensions, with their upper surfaces having some convexity, in some examples. Inflated chambers may accordingly feature peaks or hemispheric apexes, and voids can exist between the peaks/apexes of adjacent inflated chambers. These “valley-like” voids may be sized or configured based on configuring the convexity of the inflated chambers, which may be controlled by inflation fluid pressure, material composition and elasticity, and/or the like.

Further described herein are techniques for operating a pressure-mitigation device to maintain an individual in a static flat position, or within a two-dimensional plane parallel with the two-dimensional plane spanned by the pressure-mitigation device. Using specific chamber inflation patterns, an individual can be stably and statically positioned atop the pressure-mitigation device despite the dynamic motions of the pressure-mitigation device occurring underneath the individual. At each given point in time during such a chamber inflation pattern, a subset of chambers capable of supporting the individual in a flat position are inflated. The pressure-mitigation device can also include sensors that provide real-time pressure and position feedback that can be used to maintain the individual within its two-dimensional plane.

Embodiments may be described with reference to particular anatomical regions, treatment regimens, environments, etc. However, those skilled in the art will recognize that the features are similarly applicable to other anatomical regions, treatment regimens, environments, etc. As an example, embodiments may be described in the context of a pressure-mitigation device that is positioned adjacent to an anterior anatomical region of an individual oriented in the prone position. However, aspects of those embodiments may apply to a pressure-mitigation device that is positioned adjacent to a posterior anatomical region of an individual oriented in the supine position.

While embodiments may be described in the context of machine-readable instructions, aspects of the technology can be implemented via hardware, firmware, or software. As an example, a controller may not only execute instructions for determining an appropriate rate at which to permit fluid (e.g., air) flow into the inflatable chamber of a pressure-mitigation device but may also be responsible for facilitating communication with other computing devices. For example, the controller may be able to communicate with a mobile device that is associated with the individual or a caregiver, or the controller may be able to communicate with a computer server of a network-accessible server system.

### Terminology

References in this description to “an embodiment” or “one embodiment” means that the feature, function, structure, or characteristic being described is included in at least one embodiment of the technology. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense (i.e., in the sense of “including but not limited to”). The term “based on” is also to be construed in an inclusive sense rather than an exclusive or exhaustive sense. Thus, unless otherwise noted, the term “based on” is intended to mean “based at least in part on.”

The terms “connected,” “coupled,” and variants thereof are intended to include any connection or coupling between two or more elements, either direct or indirect. The connection/coupling can be physical, logical, or a combination thereof. For example, objects may be electrically or communicatively coupled to one another despite not sharing a physical connection.

The term “module” may refer to software components, firmware components, or hardware components. Modules are typically functional components that generate one or more outputs based on one or more inputs. As an example, a computer program may include multiple modules responsible for completing different tasks or a single module responsible for completing all tasks.

When used in reference to a list of multiple items, the term “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open ended.

### Example Pressure-Mitigation Devices

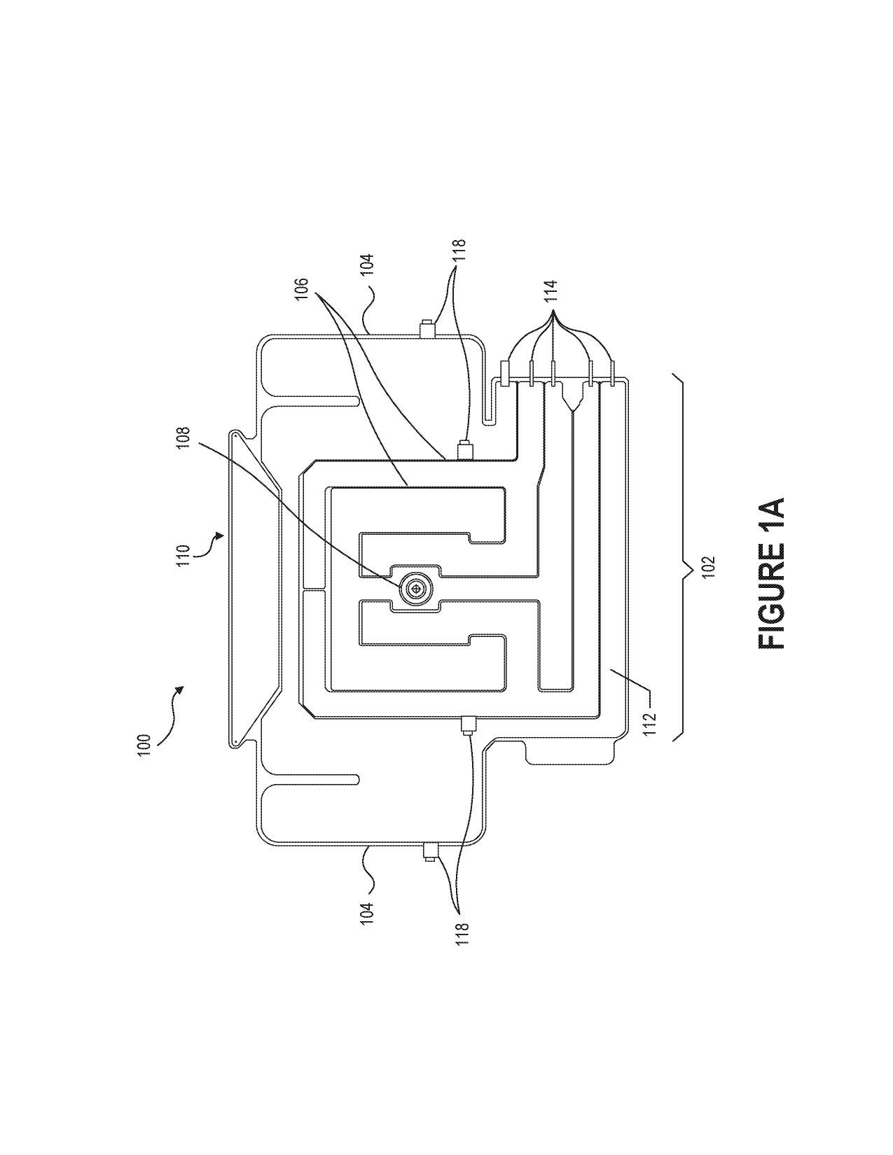

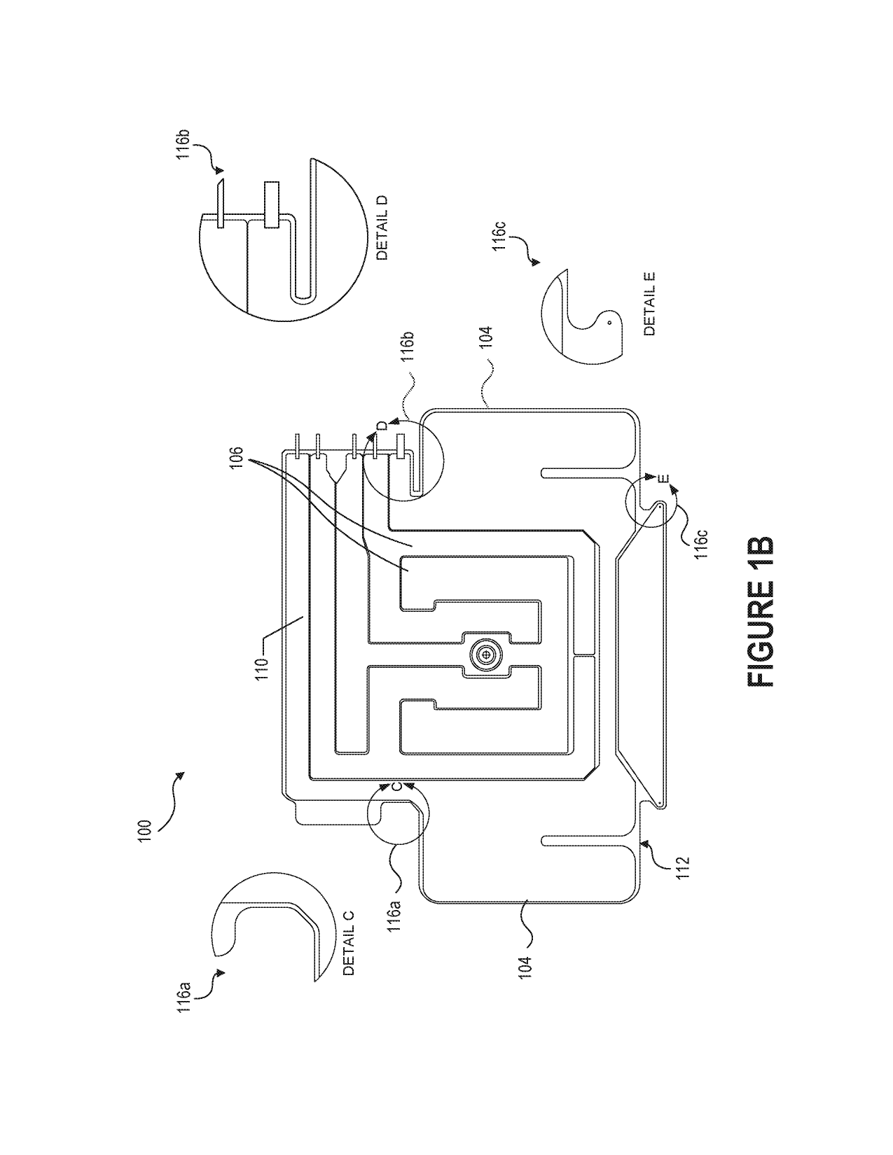

A pressure-mitigation apparatus includes a plurality of chambers or compartments that can be individually controlled to vary the pressure in each chamber and/or a subset of the chambers. When placed between a human body and a support surface, the pressure-mitigation apparatus can vary the pressure on an anatomical region by controllably inflating one or more chambers, deflating one or more chambers, or any combination thereof. Several examples of pressure-mitigation apparatuses are described below with respect to FIGS. 1A-3. Unless otherwise noted, any features described with respect to one embodiment are equally applicable to the other embodiments. Some features have only been described with respect to a single embodiment of the pressure-mitigation apparatus for the purpose of simplifying the present disclosure.

FIGS. 1A-1B are top and bottom views, respectively, of an example of a pressure-mitigation device 100, able to relieve the pressure on an anatomical region applied by the surface of an elongated object in accordance with embodiments of the present technology. While the pressure-mitigation device 100 may be described in the context of elongated objects, such as mattresses, stretchers, operating tables, and procedure tables, the pressure-mitigation device 100 could be deployed on non-elongated objects.

As shown in FIG. 1A, the pressure-mitigation device 100 can include a central portion 102 (also referred to as a “contact portion”) that is positioned alongside at least one side support 104. Here, a pair of side supports 104 are arranged on opposing sides of the central portion 102. However, some embodiments of the pressure-mitigation device 100 do not include any side supports. For example, the side support(s) 104 may be omitted when the individual is medically immobilized (e.g., under anesthesia, in a medically induced coma, etc.) and/or physically restrained by underlying object (e.g., by rails along the side of a bed, armrests along the side of a chair, etc.) or some other structure (e.g., physical restraints, casts, etc.).

The pressure-mitigation device 100 includes a series of chambers 106 whose pressure can be individually varied. In some embodiments, the series of chambers 106 are arranged in a geometric pattern designed to relieve pressure on specific anatomical region(s) of a human body. As noted above, when placed between the human body and a surface, the pressure-mitigation device 100 can vary the pressure on these specific anatomical region(s) by controllably inflating and/or deflating chamber(s).

In some embodiments, the series of chambers 106 are arranged such that pressure on a given anatomical region is mitigated when the given anatomical region is oriented over a target region 108 of the geometric pattern. As shown in FIGS. 1A-1B, the target region 108 may be representative of a central point of the pressure-mitigation device 100 to appropriately position the anatomy of the human body with respect to the pressure-mitigation device 100. For example, the target region 108 may correspond to an epicenter of the geometric pattern. However, the target region 108 may not necessarily be the central point of the pressure-mitigation device 100, particularly if the series of chambers 106 are positioned in a non-symmetric arrangement. The target region 108 may be visibly marked so that an individual can readily align the target region 108 with a corresponding anatomical region of the human body to be positioned thereon. Thus, the pressure-mitigation device 100 may include a visual element representative of the target region 108 to facilitate alignment with the corresponding anatomical region of the human body. The individual could be a physician, nurse, caregiver, or the patient.

The pressure-mitigation device 100 can include a first portion 110 (also referred to as a “first layer” or “bottom layer") designed to face a surface and a second portion 112 (also referred to as a “second layer” or “top layer") designed to face the human body supported by the surface. In some embodiments, the pressure-mitigation device 100 is deployed such that the first portion 110 is directly adjacent to the surface. For example, the first portion 110 may have a tacky substance deposited along at least a portion of its exterior surface that facilitates temporarily adhesion to the support surface. In other embodiments, the pressure-mitigation device 100 is deployed such that the first portion 110 is directly adjacent to an attachment apparatus designed to help secure the pressure-mitigation device 100 to the support surface. The pressure-mitigation device 100 may be constructed of various materials, and the material(s) used in the construction of each component of the pressure-mitigation device 100 may be chosen based on the nature of the body contact, if any, to be experienced by the component. For example, because the second portion 112 will often be in direct contact with the skin, it may be comprised of a soft fabric or a breathable fabric (e.g., comprised of moisture-wicking materials or quick-drying materials, or having perforations). In some embodiments, an impervious lining (e.g., comprised of polyurethane) is secured to the inside of the second portion 112 to inhibit fluid (e.g., sweat) from entering the series of chambers 106. As another example, if the pressure-mitigation device 100 is designed for deployment beneath a cover (e.g., a bed sheet), then the second portion 112 may be comprised of a flexible, liquid-impervious material, such as polyurethane, polypropylene, silicone, or rubber. The first portion 110 may also be comprised of a flexible, liquid-impervious material.

Generally, the first and second portions 110, 112 are selected and/or designed such that the pressure-mitigation device 100 is readily cleanable. However, the specific materials that are used may vary depending on the environment in which the pressure-mitigation device 100 is to be deployed. Assume, for example, that the pressure-mitigation device 100 is intended to be deployed in a hospital environment. In such a scenario, the first and second portions 110, 112 may be readily cleanable with a cleaning agent (e.g., bleach) or a cleaning procedure (e.g., sterilization). Because the pressure-mitigation device 100 will remain in the hospital environment under the care of knowledgeable persons, the first and second portions 110, 112 could be comprised of materials that may degrade quickly if not properly cared for. Examples of such materials include high-performance fabric, upholstery, vinyl, and other suitable textiles. If the pressure-mitigation device 100 is instead intended to be deployed in a home environment, the first and second portions 110, 112 may be comprised of materials that can be readily cleaned by persons without extensive experience. For example, the first portion 110 and/or the second portion 112 may be comprised of a vinyl that is easy to clean with commonly available cleaning agents (e.g., bleach, liquid dish soap, all-purpose cleaners). Regardless of the environment, the first and second portions 110, 112 may contain antimicrobial additives, antifungal additives, flame-retardant additives, and the like.

The series of chambers 106 may be formed via interconnections between the first and second portions 110, 112. For example, the first and second portions 110, 112 may be bound directly to one another, or the first and second portions 110, 112 may be bound to one another via one or more intermediary layers. In the embodiment illustrated in FIGS. 1A-1B, the pressure-mitigation device 100 includes an “M-shaped” chamber intertwined with two “C-shaped” chambers that face one another. Such an arrangement has been shown to effectively mitigate the pressure applied to the sacral region of a human body in the supine position by a support surface when the pressure in these chambers is alternated. The series of chambers 106 may be arranged differently if the pressure-mitigation device 100 is designed for an anatomical region other than the sacral region, or if the pressure-mitigation device 100 is to be used to support a human body in a non-supine position (e.g., a prone position or sitting position). Generally, the geometric pattern of chambers 106 is designed based on the internal anatomy (e.g., the muscles, bones, and vasculature) of the anatomical region on which pressure is to be relieved.

The person using the pressure-mitigation device 100 and/or the caregiver (e.g., a nurse, physician, family member, etc.) may be responsible for actively orienting the anatomical region of the human body lengthwise over the target region 108 of the geometric pattern. If the pressure-mitigation device 100 includes one or more side supports 104, the side support(s) 104 may actively orient or guide the anatomical region of the human body laterally over the target region 108 of the geometric pattern. In some embodiments the side support(s) 104 are inflatable, while in other embodiments the side support(s) 104 are permanent structures that protrude from one or both lateral sides of the pressure-mitigation device 100. For example, at least a portion of each side support may be stuffed with cotton, latex, polyurethane foam, or any combination thereof.

A controller can separately or independently control the pressure in each chamber (as well as the side supports 104, if included) by providing a discrete airflow via one or more corresponding valves 114. In some embodiments, the valves 114 are permanently secured to the pressure-mitigation device 100 and designed to interface with tubing that can be readily detached (e.g., for easier transport, storage, etc.). Here, the pressure-mitigation device 100 includes five valves 114. Three valves are fluidically coupled to the series of chambers 106, and two valves are fluidically coupled to the side supports 104. Other embodiments of the pressure-mitigation device 100 may include more than five valves or less than five valves. For example, the pressure-mitigation device 100 may be designed such that a pair of side supports 104 are pressurized via a single airflow received via a single valve.

In some embodiments, the pressure-mitigation device 100 includes one or more design features 116a-c designed to facilitate securement of the pressure-mitigation device 100 to the surface of an object and/or an attachment apparatus. As illustrated in FIG. 1B, for example, the pressure-mitigation device 100 may include three design features 116a-c, each of which can be aligned with a corresponding structural feature that is accessible along the surface of the object or the attachment apparatus. For example, each design feature 116a-c may be designed to at least partially envelope a structural feature that protrudes upward. One example of such a structural feature is a rail that extends along the side of a bed. The design feature(s)a- 116a-c may also facilitate proper alignment of the pressure-mitigation device 100 with the surface of the object or the attachment apparatus.

While not shown in FIGS. 1A-1B, one or more release valves (also referred to as “discharge valves”) may be located along the periphery of the pressure-mitigation device 100 to allow for quick discharge of the fluid stored therein. Normally, the release valve(s) are located along the longitudinal sides to ensure that the release valve(s) are not located beneath a human body situated on the pressure-mitigation device 100. Release valve(s) may allow discharge of fluid from the side supports 104 and/or the series of chambers 106. In some embodiments, fluid is separately or collectively dischargeable from the side supports 104 (e.g., where each side support has at least one release valve). Such a design is desirable in some scenarios because fluid can quickly be discharged from the side supports 104, which allows the human body situated on the pressure-mitigation device 100 to be accessed (e.g., in the case of a medical emergency). In other embodiments, fluid is only collectively dischargeable from the side supports 104. This approach to “dually deflating” the side supports 104 may be taken if release valve(s) are connected to only one side support, though both side supports are fluidically coupled to one another. The release valve(s) may be manually or electrically actuated. For example, the release valve(s) may be manually actuated by pressing a mechanical button (also referred to as a “strike button”) that, when pressed, allows fluid to flow out of the corresponding chamber or side support. In embodiments where the fluid is air, the air may be permitted to flow into the ambient environment. In embodiments where the fluid is water or gel, the fluid may be directed into a container (e.g., from which the fluid can then be rerouted through the controller as further discussed below). As another example, the release valve(s) may be electronically actuated by interacting with a switch assembly (e.g., located along the exterior surface of the pressure-mitigation device 100), a controller, or another computing device (e.g., a mobile phone or wearable electronic device) that is communicatively connected to the pressure-mitigation device 100.

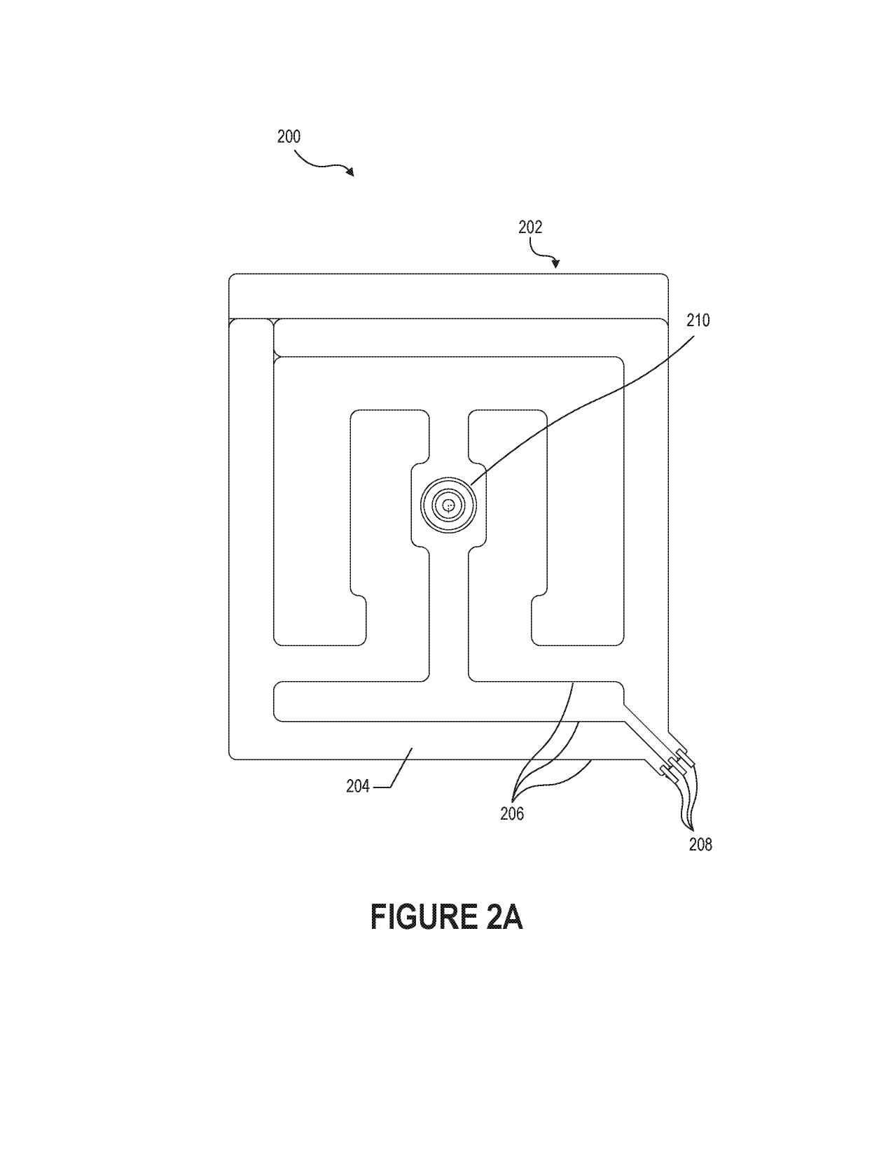

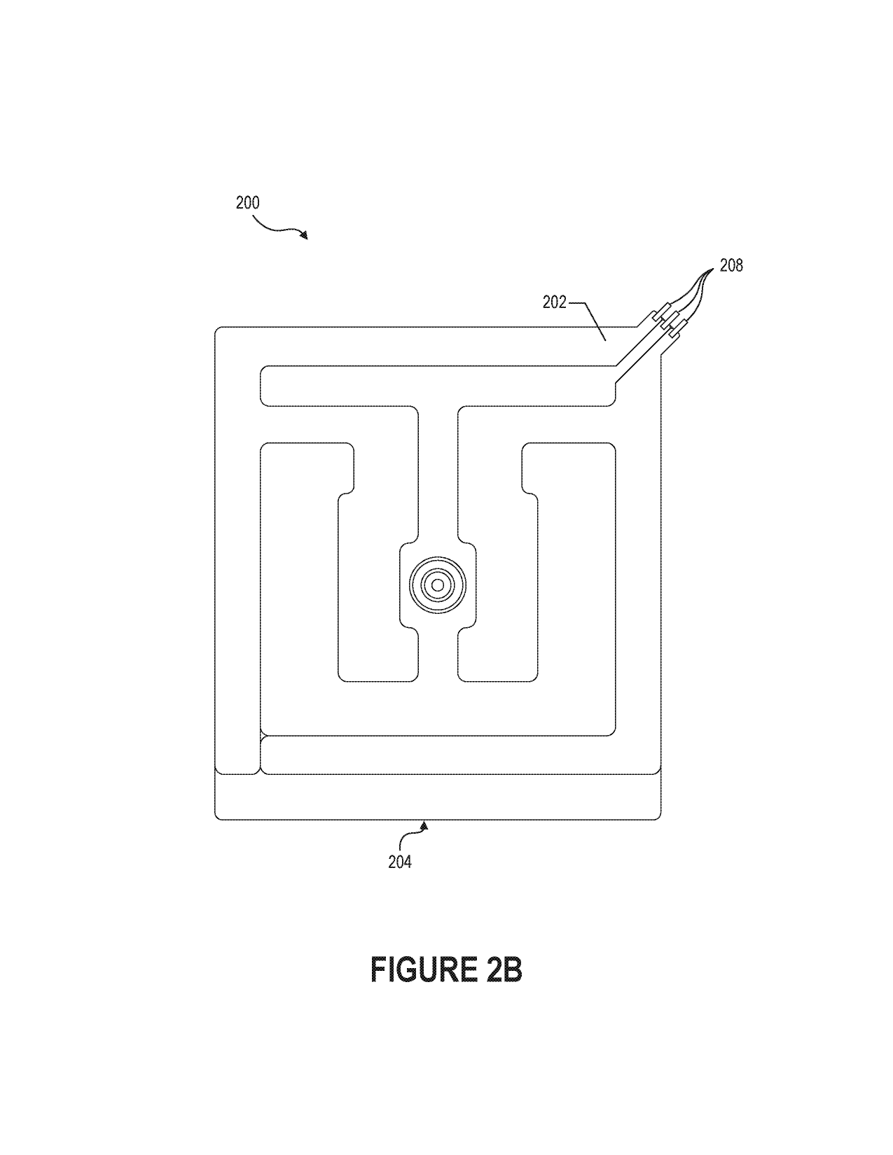

FIGS. 2A-2B are top and bottom views, respectively, of a pressure-mitigation device 200 configured in accordance with embodiments of the present technology. The pressure-mitigation device 200 is generally used in conjunction with non-elongated objects that support individuals in a seated or partially erect position. Examples of non-elongated objects include chairs (e.g., office chairs, examination chairs, recliners, and wheelchairs) and the seats included in vehicles and airplanes. Accordingly, the pressure-mitigation device 200 may be positioned atop surfaces that have side supports integrated into the object itself (e.g., the side arms of a recliner or wheelchair). Note, however, that the pressure-mitigation device 200 could likewise be used in conjunction with elongated objects in a manner generally similar to the pressure-mitigation device 100 of FIGS. 1A-1B.

The pressure-mitigation device 200 can include various features similar to the features of the pressure-mitigation device 100 described above with respect to FIGS. 1A-1B. For example, the pressure-mitigation device 200 may include a first portion 202 (also referred to as a “first layer” or “bottom layer”) designed to face the surface, a second portion 204 (also referred to as a “second layer” or “top layer”) designed to face the human body supported by the surface, and a plurality of chambers 206 formed via interconnections between the first and second portions 202, 204. In this embodiment, the pressure-mitigation device 200 includes an “M-shaped” chamber intertwined with a backward “J-shaped” chamber and a backward “C-shaped” chamber. Varying the pressure in such an arrangement of chambers 206 has been shown to effectively mitigate the pressure applied by a surface to the gluteal and sacral regions of a human body in a seated position. These chambers may be intertwined to collectively form a square-shaped pattern. Pressure-mitigation devices designed for deployment on the surfaces of non-elongated objects may have substantially quadrilateral-shaped patterns of chambers, while pressure-mitigation devices designed for deployment on the surfaces of elongated objects may have substantially square-shaped patterns of chambers.

As further discussed below, the chambers 206 can be inflated and/or deflated in a predetermined pattern and to predetermined pressure levels. The individual chambers 206 may be inflated to higher pressure levels than the chambers 106 of the pressure-mitigation device 100 described with respect to FIGS. 1A-1B because the human body being supported by the pressure-mitigation device 200 is in a seated position, thereby causing more pressure to be applied by the underlying surface than if the human body were in a supine or prone position. Further, unlike the pressure-mitigation device 100 of FIGS. 1A-1B, the pressure-mitigation device 200 of FIGS. 2A-2B does not include side supports. As noted above, side supports may be omitted when the object on which the individual is situated (e.g., seated or reclined) already provides components that will laterally center the human body, as is often the case with non-elongated support surfaces. One example of such a component is the armrests along the side of a chair.

A controller can control the pressure in each chamber 206 by providing a discrete airflow via one or more corresponding valves 208. Here, the pressure-mitigation device 200 includes three valves 208, and each of the three valves 208 corresponds to a single chamber 206. Other embodiments of the pressure-mitigation device 200 may include fewer than three valves or more than three valves, and each valve can be associated with one or more chambers to control inflation/deflation of those chamber(s). A single valve could be in fluid communication with two or more chambers. Further, a single chamber could be in fluid communication with two or more valves (e.g., one valve for inflation and another valve for deflation).

Similar to the pressure-mitigation device 100 described with respect to FIGS. 1A and 1B, the pressure-mitigation device 200 of FIGS. 2A and 2B includes a target region 210 over which a specific anatomical region can be positioned. Generally, the chambers 206 are arranged in a geometric pattern that is designed to mitigate pressure on the specific anatomical region. In some embodiments, the target region 210 represents a central point or portion of the pressure-mitigation device 200. However, as shown in FIGS. 2A and 2B, the geometric pattern of chambers 206 may not be symmetric with respect to the x-axis or y-axis that extend through the target region 210.

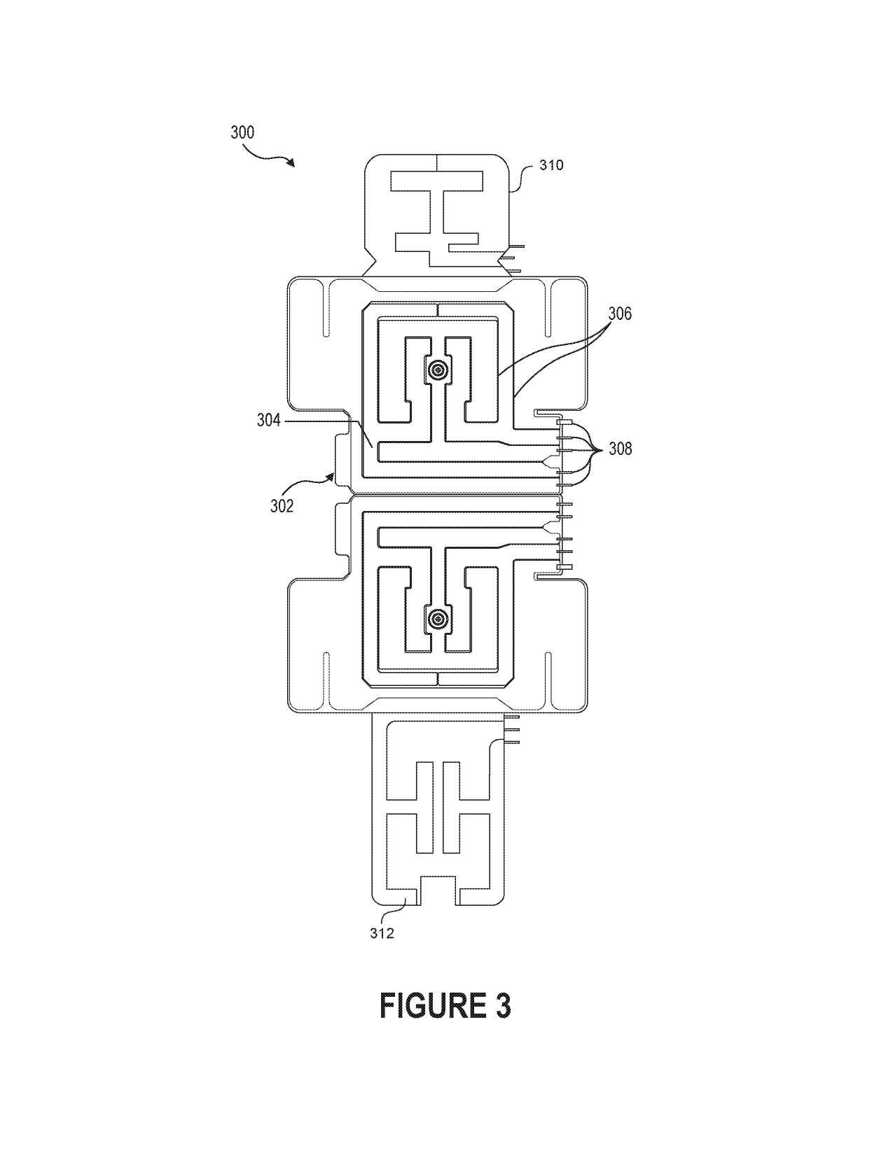

FIG. 3 is a top view of a pressure-mitigation device 300 for relieving pressure on an anatomical region applied by an elongated object in accordance with embodiments of the present technology. As mentioned above, examples of elongated objects include mattresses, stretchers, operating tables, and procedure tables. The pressure-mitigation device 300 can include features similar to the features of the pressure-mitigation device 200 of FIGS. 2A-2B, and the pressure-mitigation device 100 of FIGS. 1A-1B. For example, the pressure-mitigation device 300 can include a first portion 302 (also referred to as a “first layer” or “bottom layer”) designed to face the surface of the elongated object, a second portion 304 (also referred to as a “second layer” or “top layer”) designed to face a human body supported by the elongated object, a series of chambers 306 formed by interconnections between the first and second portions 302, 304, and multiple valves 308 that control the flow of fluid into and/or out of the chambers 306. As can be seen in FIG. 3, the pressure-mitigation device 300 may be designed such that the valves 308 will be accessible along a longitudinal side of the elongated object. Such a design may allow the tubing connected to the valves 308 to be routed alongside the elongated object (e.g., along or through a handrail of a bedframe). Alternatively, the pressure-mitigation device may be designed such that the valves 308 are located near the top or bottom of the pressure-mitigation device 300 so as to allow the tubing to be routed along a latitudinal side of the elongated object.

While some example pressure-mitigation devices described herein are designed to occupy the lumbar, gluteal, and femoral regions while the human body positioned thereon is in the supine position, the pressure-mitigation device 300 of FIG. 3 can be designed to also occupy cervical, thoracic, and leg regions. Thus, the pressure-mitigation device 300 may be able to alleviate pressure applied by the elongated object anywhere along the posterior side of the human body between the skull and ankle.

Embodiments of the pressure-mitigation device 300 could also include (i) a cranial portion 310 (also referred to as a “cranial cushion” or “cranial cup”) that is designed to envelop the posterior side of the cranium while the human body is in the supine position and/or (ii) a heel portion 312 (also referred to as a “heel cushion” or “heel cup”) that is designed to envelop the posterior end of the foot while the human body is in the supine position. The cranial portion 310 and heel portion 312 may include a different number of chambers than the geometric arrangements designed to occupy the lumbar and femoral regions. Generally, the cranial portion 310 and heel portion 312 only include one or two chambers, though the cranial portion 310 and heel portion 312 could include more than two chambers. In embodiments where the pressure-mitigation device 300 includes cranial and heel portions, the pressure-mitigation device 300 may be referred to as a “full-body pressure-mitigation device.” In embodiments where the pressure-mitigation device 300 includes cranial and heel portions, the pressure-mitigation device 300 may have a longitudinal form that is at least six feet in length. In embodiments where the pressure-mitigation device 300 does not include cranial and heel portions, the pressure-mitigation device 300 may have a longitudinal form that is at least four feet in length.

As shown in FIG. 3, the pressure-mitigation device 300 can include side supports 314 that are able to actively or passively orient the human body with respect to the chambers of the pressure-mitigation device 300. In some embodiments, a single side support extends longitudinally along each opposing side of the pressure-mitigation device 300. In other embodiments, multiple side supports are located along each opposing side of the pressure-mitigation device 300. As an example, along each longitudinal side, the pressure-mitigation device 300 may include a first side support that is intended to be parallel to the thoracic region and a second side support that is intended to be parallel to the leg region. As another example, along each longitudinal side, the pressure-mitigation device 300 may include a first side support that is intended to be parallel to the thoracic and lumbar regions, a second side support that is intended to be parallel to the leg region, and a third side support that is intended to be parallel to the calf region. Accordingly, the pressure-mitigation device 300 may include more than one side support along each side, and each side support may be responsible for orienting a different anatomical region of the human body.

More generally, the pressure-mitigation device 300 includes a first geometric arrangement of a first series of chambers and a second geometric arrangement of a second series of chambers. When controllably inflated, the first series of chambers can relieve the pressure applied to a first anatomical region of a human body by an underlying surface. Similarly, when controllably inflated, the second series of chambers can relieve the pressure applied to a second anatomical region of the human body by the underlying surface. When the pressure-mitigation device 300 has a longitudinal form as shown in FIG. 3, the first geometric arrangement can be longitudinally adjacent to the second geometric arrangement, so as to accommodate the first anatomical region that is superior to the second anatomical region. As shown in FIG. 3, the second geometric arrangement may be representative of another instance of the first geometric arrangement that is mirrored across a latitudinal axis that is orthogonal to the longitudinal form of the pressure-mitigation device 300. Alternatively, the second geometric arrangement may be identical to the first geometric arrangement.

Moreover, the pressure-mitigation device may include a third geometric arrangement of a third series of chambers. When controllably inflated, the third series of chambers can relieve the pressure applied to a third anatomical region of the human body by the underlying surface. The third anatomical region may be superior to the anatomical region (e.g., when the third geometric arrangement corresponds to the cranial portion 310), or the third anatomical region may be inferior to the second anatomical region (e.g., when the third geometric arrangement corresponds to the heel portion 312).

As mentioned above, the pressure-mitigation device could include cranial and heel portions in some embodiments. Therefore, the pressure-mitigation device may include a third geometric arrangement of a third series of chambers and a fourth geometric arrangement of a fourth series of chambers. When controllably inflated, the third series of chambers can relieve the pressure applied to a third anatomical region of the human body by the underlying surface. Similarly, when controllably inflated, the fourth series of chambers can relieve the pressure applied to a fourth anatomical region of the human body by the underlying surface. The third anatomical region may be superior to the first anatomical region, while the fourth anatomical region may be inferior to the second anatomical region.

### Example Approaches to Mitigating Pressure

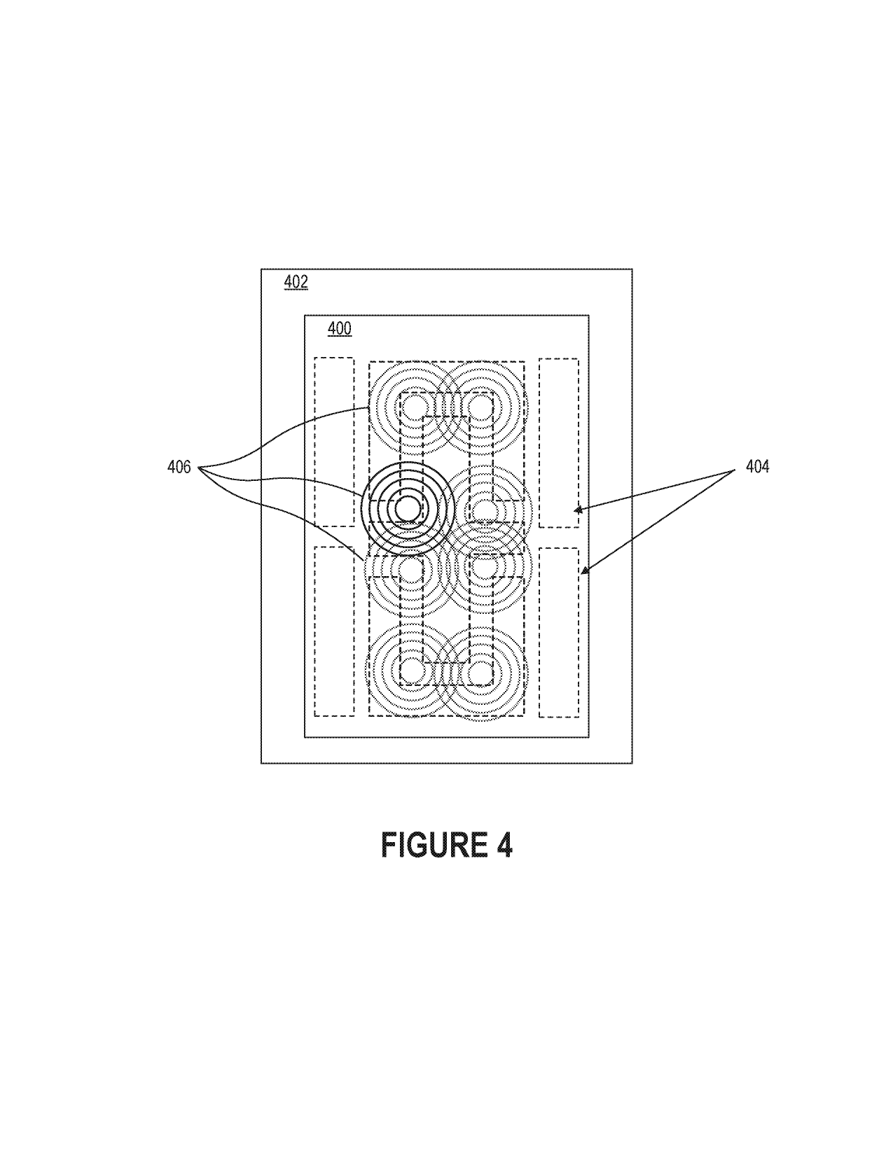

FIG. 4 is a partially schematic top view of a pressure-mitigation device illustrating how a pressure gradient can be created by varying pressure distributions to avoid ischemia in a mobility-impaired patient in accordance with embodiments of the present technology. When a human body is supported by a surface 402 of a substrate for an extended duration, pressure injuries may form in the tissue overlaying bony prominences, such as the skin overlying the sacrum, coccyx, heels, or hips. Generally, these bony prominences represent the locations at which the most pressure is applied by the surface 402 and, therefore, may be referred to as the “main pressure points” along the surface of the human body.

To prevent the formation of pressure injuries, healthy individuals periodically make minor positional adjustments (also known as “micro-adjustments”) to shift the location of the main pressure point. However, individuals having impaired mobility often cannot make these micro-adjustments by themselves. Mobility impairment may be due to physical injury (e.g., a traumatic injury or a progressive injury), movement limitations (e.g., within a vehicle, on an aircraft, or in restraints), medical procedures (e.g., those requiring anesthesia), and/or other conditions that limit natural movement. For these mobility-impaired individuals, the pressure-mitigation device 400 can be used to shift the location of the main pressure point(s) on their behalf. That is, the pressure-mitigation device 400 can create moving pressure gradients to avoid sustained, localized vascular compression and enhance tissue perfusion.

The pressure-mitigation device 400 can include a series of chambers 404 whose pressure can be individually varied. The chambers 404 may be formed by interconnections between the top and bottom layers of the pressure-mitigation device 400. The top layer may be comprised of a first material (e.g., a permeable, non-irritating material) configured for direct contact with a human body, while the bottom layer may be comprised of a second material (e.g., a non-permeable, gripping material) configured for direct contact with the surface 402. Generally, the first material is permeable to gasses (e.g., air) and/or liquids (e.g., water and sweat) to prevent buildup of fluids that may irritate the skin. Meanwhile, the second material may not be permeable to gasses or liquids to prevent soilage of the underlying object. Accordingly, air discharged into the chambers 404 may be able to slowly escape through the first material (e.g., naturally or via perforations) but not the second material, while liquids may be able to penetrate the first material (e.g., naturally or via perforations) but not the second material. Note, however, that the first material is generally be selected such that the top layer does not actually become saturated with liquid to reduce the likelihood of irritation. Instead, the top layer may allow liquid to pass therethrough into the cavities, from which the liquid can be subsequently discharged (e.g., as part of a cleaning process). The top layer and/or the bottom layer can be comprised of more than one material, such as a coated fabric or a stack of interconnected materials.

The pressure-mitigation device 400 may be designed such that inflation of at least some of the chambers 404 causes air to be continuously exchanged across the surface of the human body. Said another way, simultaneous inflation of at least some of the chambers 404 may provide a desiccating effect to inhibit generation and/or collection of moisture along the skin in a given anatomical region. In some embodiments, the pressure-mitigation device 400 is able to maintain airflow through the use of a porous material. For example, the top layer may be comprised of a biocompatible material through which air can flow (e.g., naturally or via perforations). As further discussed in embodiments described below, the pressure-mitigation device 400 is able to maintain airflow without the use of a porous material. For example, airflows can be created and/or permitted simply through varied pressurization of the chambers 404. This represents a new approach to microclimate management that is enabled by simultaneous inflation and deflation of the chambers 404. At a high level, each void formed beneath a human body due to deflation of at least one chamber can be thought of as a microclimate that cools and desiccates the corresponding portion of the anatomical region. Heat and humidity can lead to injury (e.g., further development of ulcers), so the cooling and desiccating effects may present some injuries due to inhibition of moisture generation/collection along the skin in the anatomical region.

In some embodiments, a pump (also referred to as a “pressure device”) can be fluidically coupled to each chamber 404 (e.g., via a corresponding valve) of each pressure-mitigation device, while a controller can control the flow of fluid generated by the pump into each chamber 404 on an individual basis in accordance with a predetermined pattern. The controller can operate the series of chambers 404 in several different ways.

In some embodiments, the chambers 404 have a naturally deflated state, and the controller causes the pump to inflate at least one of the chambers 404 to shift the main pressure point along the anatomy of the human body. For example, the pump may inflate at least one chamber located directly beneath an anatomical region to momentarily apply contact pressure to that anatomical region and relieve contact pressure on the surrounding anatomical regions adjacent to the deflated chamber(s). Alternatively, the controller may cause the pump to inflate two or more chambers adjacent to an anatomical region to create a void beneath the anatomical region to shift the main pressure point at least momentarily away from the anatomical region.

In other embodiments, the chambers 404 have a naturally inflated state, and the controller may cause deflation of at least one of the chambers 404 to shift the main pressure point along the anatomy of the human body. For example, the pump may cause deflation of at least one chamber located directly beneath an anatomical region, thereby forming a void beneath the anatomical region to momentarily relieve the contact pressure on the anatomical region. To deflate a chamber, the controller may simply prevent an airflow generated by the pump from entering the chamber as further discussed below. Additionally or alternatively, the controller may cause air contained in the chamber to be released (e.g., via a valve). At least partial deflation may naturally occur in this scenario if air escapes through the valve quicker than air enters the chamber.

Whether configured in a naturally deflated state or a naturally inflated state, the continuous or intermittent alteration of the inflation levels of the individual chambers 404 moves the location of the main pressure point across different portions of the human body. As shown in FIG. 4, for example, inflating and/or deflating the chambers 404 creates temporary contact regions 406 that move across the pressure-mitigation device 400 in a predetermined pattern, and thereby changing the location of the main pressure point(s) on the human body for finite intervals of time. Thus, the pressure-mitigation device 400 can simulate the micro-adjustments made by healthy individuals to relieve stagnant pressure applied by the surface 402.

The series of chambers 404 may be arranged in an anatomy-specific pattern so that when the pressure of one or more chambers is altered, the contact pressure on a specific anatomical region of the human body is relieved (e.g., by shifting the main pressure point elsewhere). As an example, the main pressure point may be moved between eight different locations corresponding to the eight temporary contact regions 406 as shown in FIG. 4. In some embodiments the main pressure point shifts between these locations in a predictable manner (e.g., in a clockwise or counter-clockwise pattern), while in other embodiments the main pressure point shifts between these locations in an unpredictable manner (e.g., in accordance with a random pattern or a semi-random pattern, based on the amount of force applied by the human body to the chambers, or based on the pressure of the chambers). Those skilled in the art will recognize that the number and position of these temporary contact regions 406 may vary based on the size of the pressure-mitigation device 400, the arrangement of chambers 404, the number of chambers 404, the anatomical region supported by the pressure-mitigation device 400, the characteristics of the human body supported by the pressure-mitigation device 400, the condition of the human body (e.g., whether the person is completely immobilized, partially immobilized, etc.), or any combination thereof.

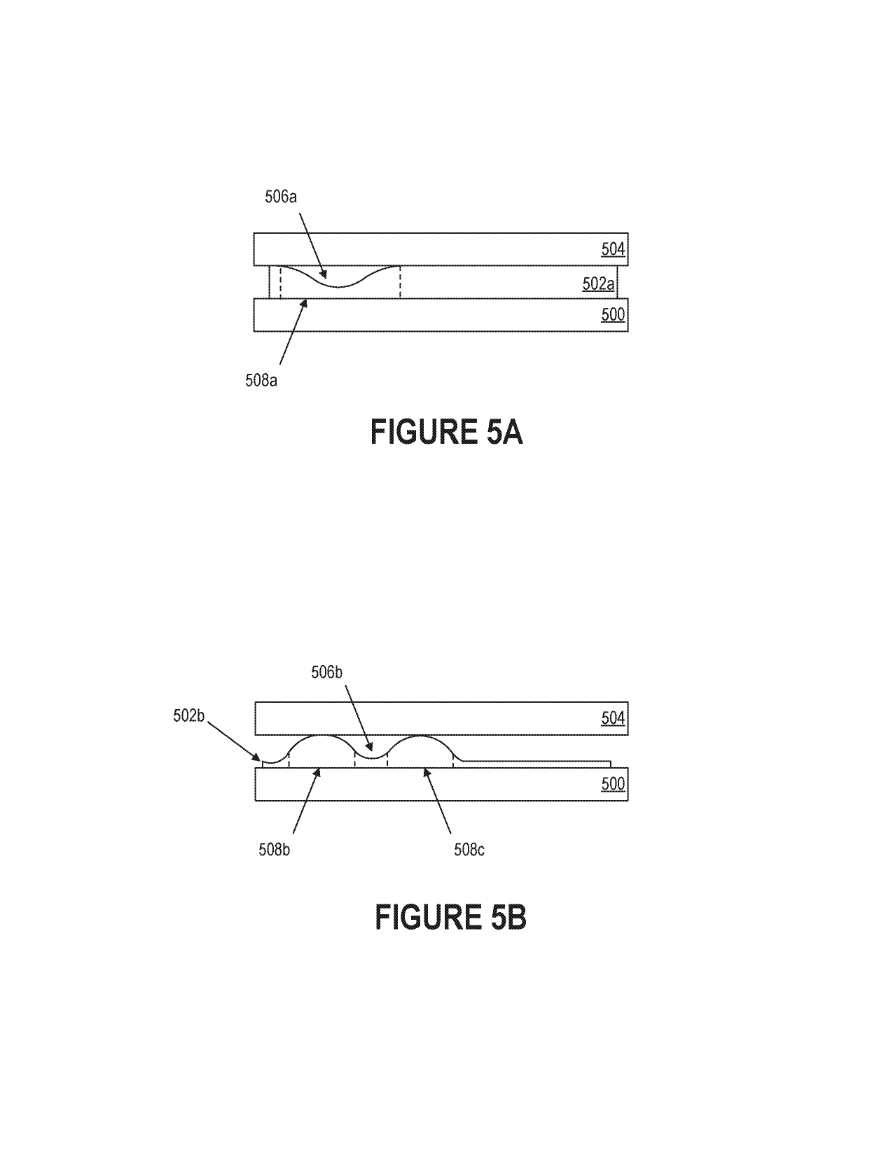

FIG. 5A is a partially schematic side view of a pressure-mitigation device 502a, for relieving pressure on a specific anatomical region by deflating one or more chambers in accordance with embodiments of the present technology. The pressure-mitigation device 502a can be positioned between the surface of an object 500 and a human body 504. Examples of objects 500 include elongated objects, such as mattresses, stretchers, operating tables, and procedure tables, and non-elongated objects, such as chairs (e.g., office chairs, examination chairs, recliners, and wheelchairs) and the seats included in vehicles and airplanes. To relieve the pressure on a specific anatomical region of the human body 504, at least one chamber 508a of multiple chambers (collectively referred to as "chambers 508") proximate to the specific anatomical region is at least partially deflated to create a void 506a beneath the specific anatomical region. In such embodiments, the remaining chambers 508 may remain inflated. Thus, the pressure-mitigation device 502a may sequentially deflate chambers (or arrangements of multiple chambers) to relieve the pressure applied to the human body 504 by the surface of the object 500.

FIG. 5B is a partially schematic side view of a pressure-mitigation device 502b for relieving pressure on a specific anatomical region by inflating one or more chambers in accordance with embodiments of the present technology. For example, to relieve the pressure on a specific anatomical region of the human body 504, the pressure-mitigation device 502b can inflate two chambers 508b and 508c disposed directly adjacent to the specific anatomical region to create a void 506b beneath the specific anatomical region. In such embodiments, the remaining chambers may remain partially or entirely deflated. Thus, the pressure-mitigation device 502b may sequentially inflate a chamber (or arrangements of multiple chambers) to relieve the pressure applied to the human body 504 by the surface of the object 500.

In some embodiments, the pressure-mitigation devices 502a, 502b of FIGS. 5A-5B have the same configuration of chambers 508 and can operate in both a normally inflated state (described with respect to FIG. 5A) and a normally deflated state (described with respect to FIG. 5B) based on the selection of an operator (e.g., the user or some other person, such as a medical professional or family member). For example, the operator can use a controller to select a normally deflated mode such that the pressure-mitigation device operates as described with respect to FIG. 5B, and then change the mode of operation to a normally inflated mode such that the pressure-mitigation device operates as described with respect to FIG. 5A. Thus, the pressure-mitigation devices described herein can shift the location of the main pressure point by controllably inflating chambers, controllably deflating chambers, or a combination thereof.

### Example Approaches to Dimensional Construction and Operation

Embodiments described herein are directed to optimization of pressure-mitigation device construction via an initial two-dimensional deflated state or form. Generally, a pressure-mitigation device is constructed such that the device includes no excess material bunches or wrinkles while the chambers are in the deflated state based on the device lacking excess material in the deflated state. Thus, the pressure-mitigation device can have a substantially planar form when completely uninflated, with two material layers substantially lying flat atop one another. In some embodiments, the pressure-mitigation device in its deflated state is entirely within 110%, within 125%, within 150%, or within 200% of the normal thickness of its material layers. That is to say, the pressure-mitigation device lacks material wrinkles or bunches that rise above the flat material layers by a significant amount.

Bunching or wrinkling of excess material forms pressure points for a user disposed atop the pressure-mitigation device, thus being counter-productive to the pressure therapy delivered to the user and being uncomfortable for the user. Thus, several examples of pressure-mitigation devices are described herein that are able to more completely minimize pressure injuries for a resting or immobilized user, even if the chambers spend meaningful amounts of time (e.g., from several minutes to several hours) in the deflated state. Furthermore, a pressure-mitigation device can be constructed to specifically address pressure or force distributions uniquely exerted by a user (e.g., compared to other users) and to create microclimate voids between chambers to provide physiological benefits to the user.

Embodiments described herein include separate pressure-mitigation devices that may be laid atop a mattress, chair, platform, table, or other surface to provide the pressure therapy, as well as in-built pressure-mitigation device integrated into the top of a mattress, the seat of a chair, and/or the like.

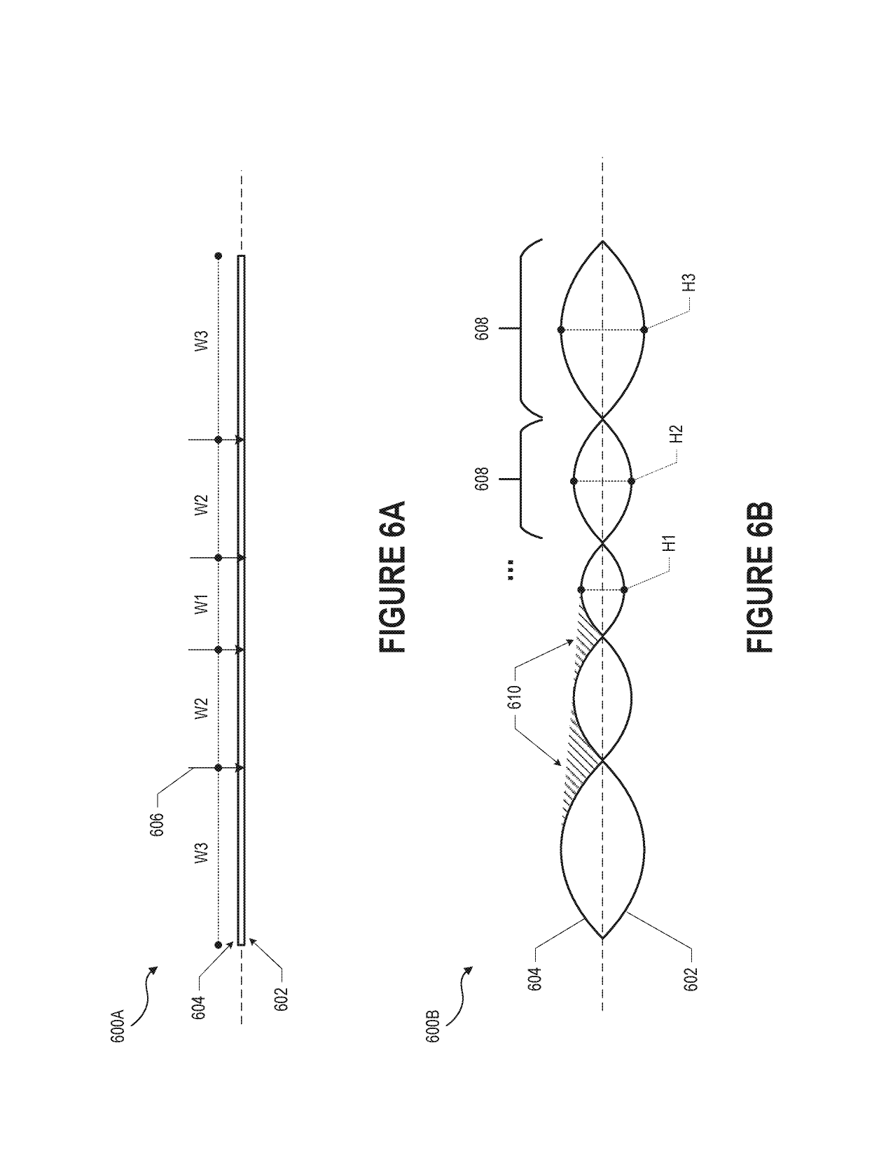

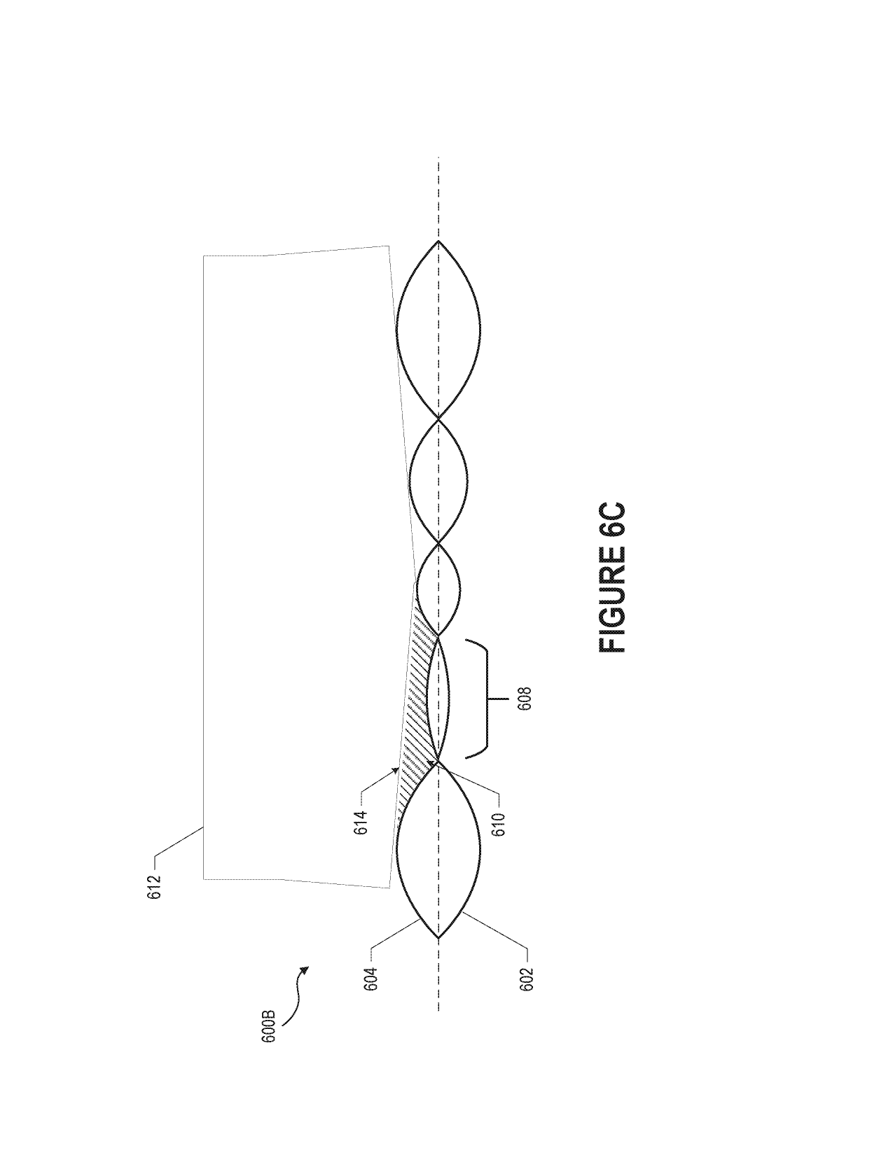

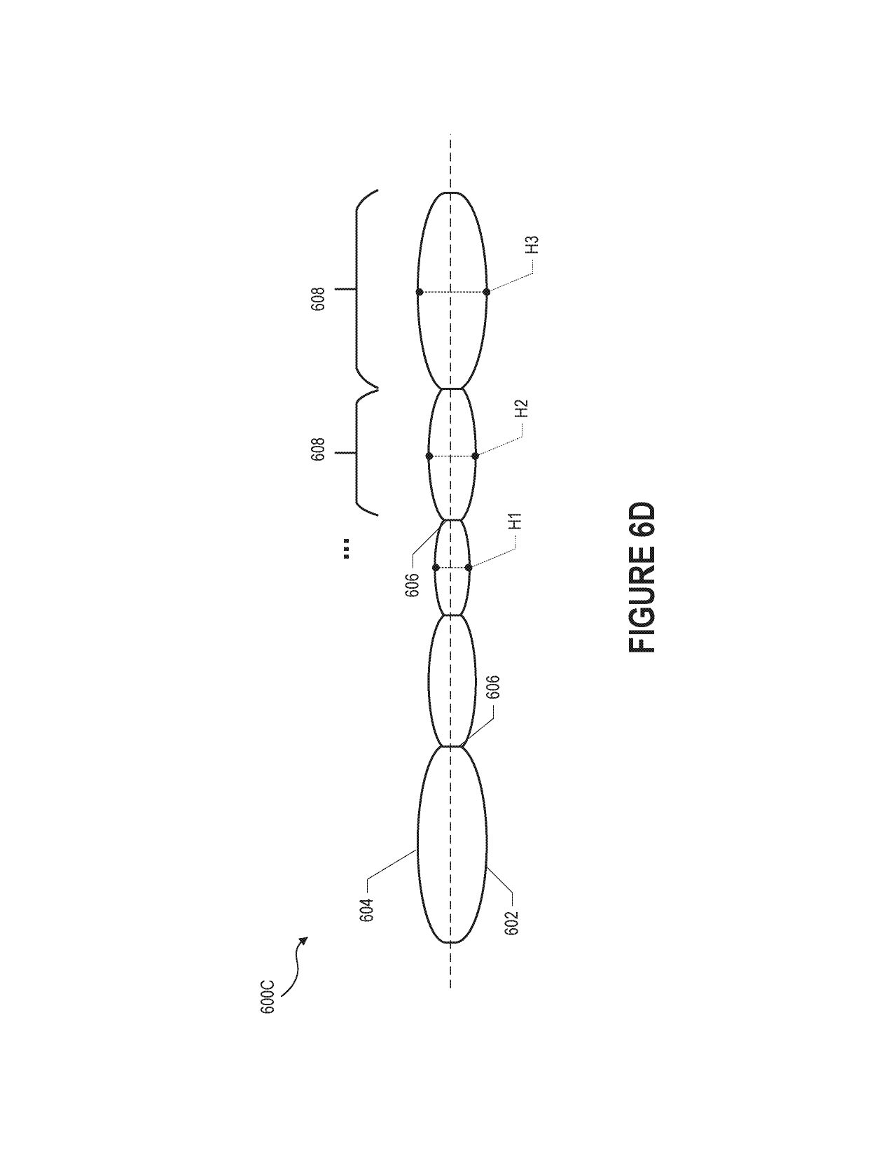

FIGS. 6A-6C demonstrate approaches to construction of pressure-mitigation devices to optimize pressure therapy provided to users. According to example embodiments, chambers of a pressure-mitigation device are defined and constructed first with respect to a substantially two-dimensional deflated state of the pressure-mitigation device (as represented by FIG. 6A) in order to control characteristics and properties of inflated states of the pressure-mitigation device (as represented by FIGS. 6B and 6C). Referring first to FIG. 6A, a pressure-mitigation device is illustrated in a deflated state 600A, in which the pressure-mitigation device has a substantially two-dimensional form, an approximately flat form, a form with a minimal height, and/or the like. The pressure-mitigation device in its deflated state 600A can be characterized by a first layer 602 and a second layer 604 (e.g., corresponding to the first portion 202 and the second portion 204 shown and described with FIGS. 2A and 2B), with the second layer 604 being laid substantially flat atop the first layer 602. The second layer 604 and the first layer 602 can be coupled together while substantially flat or parallel with one another, and the first layer 602 and the second layer 604 together sans material bunching or wrinkling is taken as the deflated state 600A of the pressure-mitigation device.

These two layers can form a complete and separate pressure-mitigation device that may be laid atop a mattress, for example. The laid pressure-mitigation device may further be secured to the mattress, permanently via stitching to thereby produce a pressure therapy mattress, or temporarily via securement features such as mechanical fasteners (e.g., clips, buckles, and the like), ties, adhesives (e.g., permanent or semi-permanent glues, hook-and-loop fasteners, and the like), etc. In other embodiments, the first layer 602 and the second layer 604 are integrated into the mattress. For example, during manufacturing of the mattress, the first layer 602 and the second layer 604 are added above one or more various layer portions of the mattress.

As discussed above, a flatness of the pressure-mitigation device, or a lack of wrinkles or bunching, can be defined with respect to a height of the pressure-mitigation device as a percentage of the normal thicknesses of the first layer 602 and the second layer 604. Alternatively, or additionally, flatness can be defined with respect to a spatial or height-wise variability of the second layer 604 or top layer of the pressure-mitigation device. For example, when the device is completely deflated, the second layer 604 has an absolute uppermost point and an absolute lowermost point. When the pressure-mitigation device is approximately flat without bunching or wrinkling, the absolute uppermost point and the absolute lowermost point differ by less than a given amount, for example, by less than 3 millimeters, less than 5 millimeters, less than 10 millimeters, and/or the like. With this minimal variability of the second layer 604, the top surface of the pressure-mitigation device is perceived by a user as flat or nearly flat.

Construction of the pressure-mitigation device initiates from this deflated state 600A of the pressure-mitigation device, and the pressure-mitigation device can then inflate out of the substantially two-dimensional form to a three-dimensional form that includes a height dimension (e.g., extending outside the minimal or “zero” height represented by the two-dimensional form). Design and construction of the pressure-mitigation device that is centered around inflation of the pressure-mitigation device from a two-dimensional form to a three-dimensional form, as opposed to design and construction based upon a deflation of the pressure-mitigation device from a three-dimensional form to a two-dimensional form, can be helpful in avoiding the inclusion of excess material in the pressure-mitigation device. That is, for example, deflation of chambers of the pressure-mitigation device would return the pressure-mitigation device to its deflated state 600A (or at least partially in some locations across a surface of the pressure-mitigation device) in which the pressure-mitigation device is substantially flat without excess material. In contrast, construction of a pressure-mitigation device as a three-dimensional structure first with a capability to deflate (e.g., based on the extraction of fluid out of the pressure-mitigation device) results in excess material that is prone to bunching and wrinkling when the pressure-mitigation device does actually deflate.

The deflated state 600A facilitates the formation or construction of chambers that can inflate out of the substantially flat (and nearly two-dimensional) configuration of the deflated state 600A. FIG. 6A illustrates a side profile or section slice of the pressure-mitigation device while in its deflated state 600A, and interconnections 606 between the first layer 602 and the second layer 604 are defined and located along section slice. A section slice of the pressure-mitigation device can be made with respect to (e.g., spanning across) a length or a width of the pressure-mitigation device. Adjacent interconnections can form a chamber along the dimension of the side profile. In the illustrated example, the interconnections 606 are located at varying widths from one another along a width of the side profile of the pressure-mitigation device in order to define/form/construct five chambers along the dimension of the side profile. While the interconnections 606 are symmetrically distributed in the illustrated example, it will be understood that different patterns or configurations may asymmetrically distribute the interconnections 606.

According to example embodiments, the interconnections 606 are distributed along the side profile based on a desired height profile, or desired heights of the formed chambers, for an inflated state of the pressure-mitigation device. Generally, a width between adjacent interconnections along the side profile can correspond to an inflated height of the formed chamber between the adjacent interconnections. The relationship between the width between a pair of adjacent interconnections and a height of the chamber formed by the adjacent interconnections can be based upon elasticity and/or other material properties and characteristics of the first layer 602 and the second layer 604.

Accordingly, in the illustrated example, parameters W1, W2, and W3 corresponding to the distribution of interconnections 606 along the side profile are determined or selected in order to realize a particular height profile of inflated chambers along the side profile (e.g., heights H1, H2, H3 corresponding to W1, W2, and W3 respectively). FIG. 6B illustrates an inflated state 600B of the pressure-mitigation device that represents an inflation of each chamber formed along the side profile according to FIG. 6A. As shown in the illustrated example, the distribution of interconnections 606 along the side profiles of FIGS. 6A and 6B forms chambers 608 that, when inflated, provide a bowl-shaped surface atop the pressure-mitigation device. In some embodiments, the dimensional construction approach is used to provide such a bowl-shaped height distribution across inflated chambers due to the bowl shape assisting in centering or orienting a user (or portion thereof) over a target region of the pressure-mitigation device, or generally due to the bowl shape stabilizing and/or maintaining a user atop the pressure-mitigation device. A concavity of the bowl shape can be effectively selected and controlled based on the spacing of the interconnections 606 along the side profile of the deflated state 600A. Other surface topologies besides the bowl shape can be provided atop the pressure-mitigation device via other spacings, distributions, or configurations of the interconnections 606 in the deflated state 600A. As discussed further below, a pressure-mitigation device may be constructed with an alternative surface topology for patient customization. As discussed above, material properties of the first layer 602 and/or the second layer 604 can affect the inflation height of chambers 608 formed between interconnections 606, and in some embodiments, the first layer 602 and the second layer 604 are formed of contiguous material, or feature uniform material properties along the dimension of the side profile. In other examples, the first layer 602 and/or the second layer 604 may include multiple composite portions with different material properties that affect chamber inflation, and the interconnections 606 are distributed along the side profile while accounting for the different material properties (e.g., an elasticity gradient) along the side profile.

In some embodiments, a width of a chamber in the deflated state 600A is not the same as the width of the chamber in the inflated state 600B. For example, as a chamber inflates and increases its height, its width may slightly decrease due to the chamber having a finite amount of material. The degree by which a chamber decreases its width as the chamber inflates may correspond to the elasticity of the material of the first layer 602 and the second layer 604. However, alignment of chambers with respect to anatomical features of an individual may be important to the therapy being provided, and narrowing of chamber widths and displacement of chambers during the inflation action may be mitigated in some embodiments. In some embodiments, to mitigate the narrowing of chamber widths during inflation (and overall decrease of surface area spanned by the device, the device may be secured to a surface (e.g., a mattress, an operating table) in a manner that stretches the device and acts counter to the decrease of surface area. In some embodiments, a size of the pressure-mitigation device in the flat deflated state is scaled up by a factor that accounts for the degree by which chambers decrease in width during inflation.

While the side profile of a pressure-mitigation device may be used to form chambers 608 with desired heights and dimensions, the side profile of the pressure-mitigation device can be alternatively or additionally used to form microclimate voids 610 that are disposed between chambers 608. These microclimate voids 610 are specifically formed to permit passage of air or fluids to alleviate heat and humidity that may arise at the interface between the user and the pressure-mitigation device. As shown, a microclimate void 610 can exist between two chambers 608 that are inflated, and further, a microclimate void 610 can be enlarged or created upon deflating certain chambers. In some embodiments, chambers are formed to optimize at least a distribution or locations of microclimate voids 610 across the pressure-mitigation device, a size or volume of a microclimate void 610, and/or the like. For example, a size or volume of a microclimate void 610 can depend upon the size or dimensions of adjacent chambers, and a difference between respective sizes of adjacent chambers; accordingly, the chambers 608 can be formed via the side profile of the pressure-mitigation device based on desired characteristics of microclimate voids 610 along the side profile. In some embodiments, the inclusion of microclimate voids provides cooling relief and air circulation for the user, and allows for the second layer 604 to be composed of impermeable material, or material impermeable to the fluid used to inflate the chambers 608. As such, the chambers 608 can be more efficiently inflated without loss of inflating fluid through the second layer 604, while the user can still be relieved from irritation via the microclimate voids.

FIG. 6C also illustrates an example of microclimate void 610 being provided by the pressure-mitigation device in its inflated state 600B. Relative to the example shown in FIG. 6B, the microclimate void 610 shown in FIG. 6C is enlarged based on the partial deflation of a chamber 608. Through enlargement of the microclimate void 610, a subject 612 having a surface 614 at which the microclimate void 610 is defined can enjoy physiological benefits. For example, the surface 614, as a result of the chamber 608 deflating and introducing the microclimate void 610 thereat, can enjoy cooling and desiccating effects. Thus, in some embodiments, microclimate voids 610 can be enlarged, or conversely rendered smaller, beyond their configured size/shape based on the controlled inflation and deflation of chambers 608. The chamber 608 enlarging the microclimate void 610 in FIG. 6C can be controllably deflated in response to a temperature sensor measuring an increased temperature of the surface 614 (due to the chamber 608 being in contact with the surface 614). It may be appreciated that the microclimate voids 610 shown in FIGS. 6B and 6C can be defined as tunnels in a three-dimensional perspective, so that outside air flows freely within, or in-and-out of, the microclimate voids 610.

As will be understood from the present disclosure, the construction of an inflatable pressure-mitigation device from substantially flat or two-dimensional deflated state (in contrast to the construction of a deflatable device from a three-dimensional form) facilitate the formation and design of microclimate voids 610, as material tensions/elasticity of the first layer and the second layer results in chambers being inflated to an elliptical or ovular sectional shape (as shown in FIG. 6B). It may be recognized that an initial three-dimensional construction of a pressure-mitigation device that then deflates to a deflated form instead includes excess material in the place of the microclimate voids 610 provided by the described embodiments. In some embodiments, a number of microclimate voids 610 along the side profile corresponds to a number of chambers that are formed along the side profile, and thus, in order to form a desired number of microclimate voids 610, a corresponding number of interconnections 606 may be formed along the side profile.

The inflated state 600B of FIG. 6B is shown in a “sewn-through” configuration, in which each interconnection 606 fully intertwines the first layer 602 and the second layer 604, fully connects the first layer 602 and the second layer 604 with one another, and/or the like. For example, an interconnection 606 sews through, attaches, or otherwise connects a point of the first layer 602 and a point of the second layer 604. This “sewn-through” configuration shown in FIG. 6B is contrasted against a “baffle-box” configuration shown in FIG. 6D. According to the “baffle-box” configuration, the inflated state 600C shown in FIG. 6D does not include interconnections 606 that attach or fully connect a first layer 602 with a second layer 604. Instead of a “sewn-through” point, the interconnections 606 shown in FIG. 6D are configured as vertical walls that span a distance or height between the first layer 602 and the second layer 604. In accordance with the described embodiments, the “baffle-box” configuration in its deflated state may maintain the first layer 602 and the second layer 604 approximately parallel and flat with one another with a minimal height, and to do so, a minimum amount of fluid is maintained within the chambers 608. By not fully vacating the chambers 608, the second layer 604 can be supported flat or parallel above the first layer 602, and the interconnections 606 formed as vertical walls do not collapse. The collapsing of vertical walls would result in excess material that can bunch and wrinkle to form additional pressure points, and therefore, maintaining the second layer 604 flat or parallel at a height above the first layer 602 can be important in minimizing such undesirable effects.

When compared to the “sewn-through” configuration demonstrated in FIG. 6B, the “baffle-box” configuration may feature less of a height differential when inflating and deflating chambers, and the microclimate voids that may occur between inflated chambers may be of reduced size. However, with the minimum pressure maintained within at its deflated state, the “baffle-box” configuration may feature increased comfort for the user, especially if the elongated object or substrate underneath the pressure-mitigation device is rigid or hard object. Accordingly, a pressure-mitigation device configured with a “sewn-through” configuration and a pressure-mitigation device configured with a “baffle-box” configuration can be selected based on the needs of the user.

In some embodiments, a “baffle-box” configuration as demonstrated in FIG. 6D may be integrated into a mattress, a cushion, a pad, and/or the like. For example, the pressure-mitigation device shown in FIG. 6D may be one of the layers included in a mattress above coil layers and/or foam layers. The pressure-mitigation device shown in FIG. 6D may be the uppermost layer of a mattress.

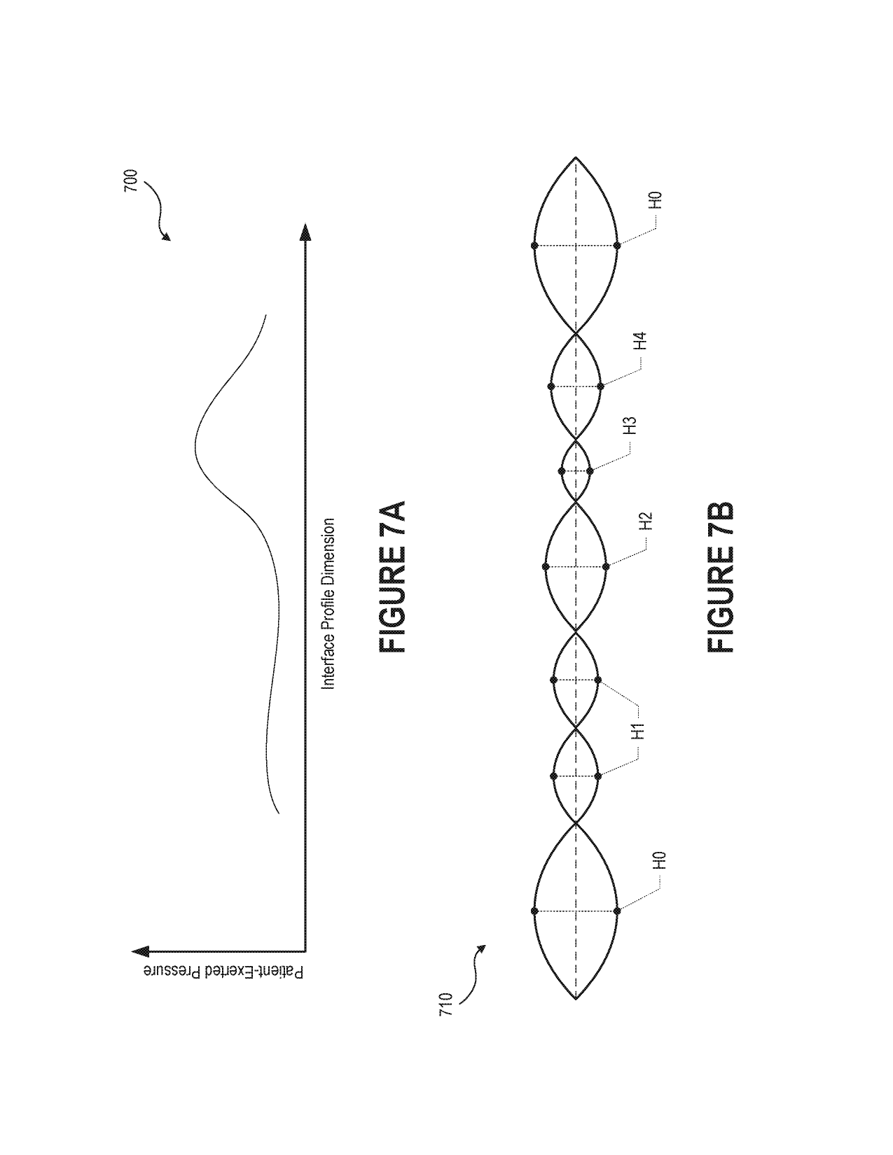

FIGS. 7A and 7B further demonstrate formation of chambers via a substantially flat deflated state of the pressure-mitigation device based on a desired surface topology or shape. Aforementioned examples and embodiments included forming chambers that provide a bowl-shaped surface topology. According to some embodiments, the desired surface topology can be determined or selected based on unique or specific user behavior or patterns. Users of different shapes and sizes can exert pressure or force upon the pressure-mitigation device in different locations or distributions. As an illustrative example, with respect to a pressure-mitigation device placed underneath a thoracic portion of a user, female users with relatively more mass in a pectoral region may exert a weight distribution upon the pressure-mitigation device that is different than another weight distribution exerted by male users with more uniform mass distributed throughout their thoracic portions. To account for different weight/pressure/force distributions by different users, a surface topology can be customized for users, for example, to provide additional cushioning and support at points where relatively larger weights/pressures/forces are exerted upon the pressure-mitigation device.

Referring first to FIG. 7A, an example of a pressure map 700 is shown. The pressure map 700 describes a distribution of weight exerted by a user along at least one dimension of the pressure-mitigation device. In the illustrated example, the pressure map 700 describes weight distribution along a dimension of a side profile of a pressure-mitigation device 710 shown in FIG. 7B. In some embodiments, a weight distribution along a particular dimension or slice (e.g., a section slice, a profile slice) of the pressure-mitigation device 710 can be obtained from a surface pressure map, or a “three-dimensional” map describing weight distribution across a two-dimensional surface.

The pressure map 700 can then be inverted to determine a desired height profile of inflated chambers of the pressure-mitigation device 710. For example, a peak in the pressure map 700 is accounted for by a chamber that inflates to a relatively lower height compared to its neighboring chambers (e.g., an example chamber with height H3 and neighbored by chambers with respective heights H2 and H4, in the illustrated example of FIG. 7B). Conversely, valleys in the pressure map 700 can correspond to chambers that inflate to relatively higher heights. By varying chamber heights along a side profile according to pressure/weight distribution exerted by a user, the pressure-mitigation device can uniformly or evenly support the user during the pressure-mitigation therapy.

As shown in FIG. 7B, the pressure-mitigation device 710 can include further chambers that may extend past the pressure map 700 or not necessarily correspond to the pressure map 700, in order to preserve a general bowl-shape or contour for the surface topology of the pressure-mitigation device 710. In the illustrated example, the pressure-mitigation device 710 includes two chambers each with heights H0 that are relatively larger than the other chamber heights between the two chambers, and these two chambers realize a bowl-shape contour in addition to the surface topology corresponding to the inverse of the pressure map 700. Thus, user stability and positioning functionality can be preserved while also customizing surface topology for unique user weight distributions.

Alternative or in addition to pressure maps 700, construction of the pressure-mitigation devices can be guided by heat maps that describe areas or regions of the user that are prone to heat generation/retention and that may require cooling. These heat maps can specifically guide construction of the pressure-mitigation devices in identifying locations where microclimate voids should be formed, or where microclimate voids should be formed with larger sizes.

In some embodiments, the pressure maps (and heat maps, in some examples) aid in constructing classes of pressure-mitigation devices that are specific to users or cohorts of users. A pressure map 700 can describe average pressure/weight distribution by a representative group of users belonging to a given cohort (e.g., gender, weight range), and pressure-mitigation devices specific to the given cohort can be constructed based on the pressure map 700.

In some embodiments, pressure maps and heat maps in some examples can be guided by physiological response of users. As discussed above, a construction of a pressure-mitigation device is intended to neutralize or counteract the pressure maps and heat maps, or more specifically, neutralize or counteract the potentially harmful unequal distributions of pressure and heat indicated in the pressure maps and heat maps. Accordingly, in some embodiments, multiple pressure maps can be collected for an individual over time while also monitoring the physiological response of the individual. Pressure maps associated with negative physiological responses are taken as harmful pressure distributions to be negated and are used for the construction of a pressure-mitigation device. Similarly, heat maps associated with negative physiological responses are specifically used for the construction of a pressure-mitigation device, instead of heat maps that are associated with normal or beneficial physiological responses. In some embodiments, a difference between a first pressure map associated with a negative physiological response and a second pressure map associated with a positive physiological response is determined. Rather than configuring a pressure-mitigation device to negative the first pressure map (e.g., to an equally-distributed pressure), a pressure-mitigation device can be configured to transform the first pressure map to the second pressure map to encourage the positive physiological response in the individual. Generally, a chamber with a greater inflated height (relative to its neighboring chambers) can increase the pressure experienced by an individual at a corresponding location, while a chamber with a lower inflated height lowers the pressure experienced at that location. With this, the pressure experienced according to the first pressure map can be transformed with specific chamber heights to a physiologically-beneficial pressure indicated by the second pressure map.

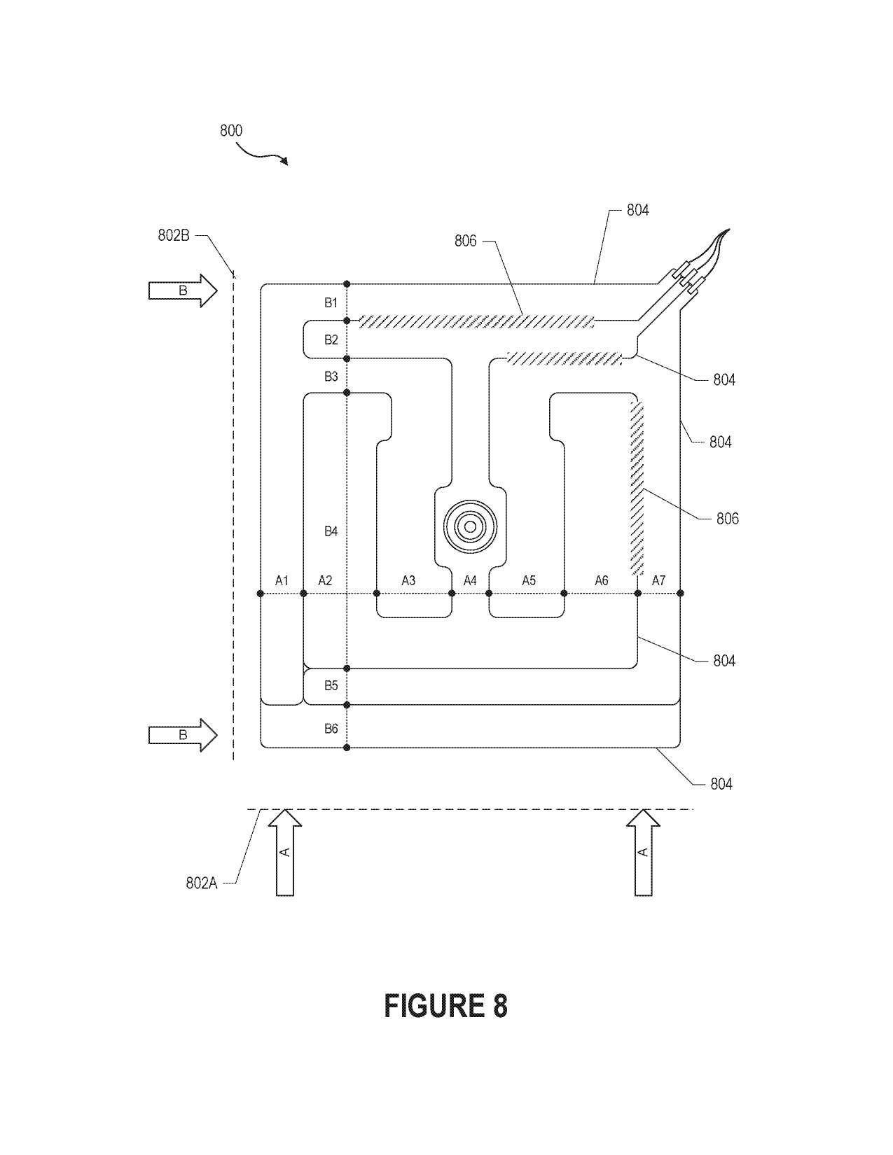

FIG. 8 provides a top view of an example pressure-mitigation device that can be constructed according to the aforementioned examples and embodiments. For example, the pressure-mitigation device 800 is constructed based on forming chambers 804 along multiple side profiles or section slices of the pressure-mitigation device 800. The 2D-to-3D construction approach demonstrated in FIGS. 6A and 6B for example occurs in one profile or section slice of the pressure-mitigation device, and to fully construct the pressure-mitigation device, the approach can be integrated along dimensions of pressure-mitigation device.

In the illustrated example, a chamber pattern or layout across a length and width of the pressure-mitigation device 800 can be formed or designed based on integrating the side-profile approach along the length and width of the pressure-mitigation device 800. For example, a first section slice 802A that spans across a given width of the pressure-mitigation device 800 can be used to determine chamber sizes A1, A2, A3, A4, A5, A6, and A7 to realize a desired surface topology across the given width of the pressure-mitigation device 800 and/or to form microclimate voids 806 across the given width of the pressure-mitigation device 800. Likewise, a second section slice 802B that spans across a given length of the pressure-mitigation device 800 can be used to determine chamber sizes B1, B2, B3, B4, B5, and B6 across the given length of the pressure-mitigation device 800. Additional slices across other widths and other lengths of the pressure-mitigation device 800 can be used to fully map out chamber sizes across a two-dimensional chamber layout of the pressure-mitigation device 800.

In some embodiments, the profile- or slice-based determination of chamber sizes is used after a number of chambers 804 existing along a profile or slice of the pressure-mitigation device 800 is determined. For example, it may be pre-determined or desired for the pressure-mitigation device 800 to include an “M-shaped” chamber intertwined with a backwards “J-shaped” chamber and a backwards “C-shaped” chamber. Following an arrangement of these chamber shapes, the profile- or slice-based approach can be used to precisely determine dimensions (e.g., chamber widths) of portions of the chamber shapes.

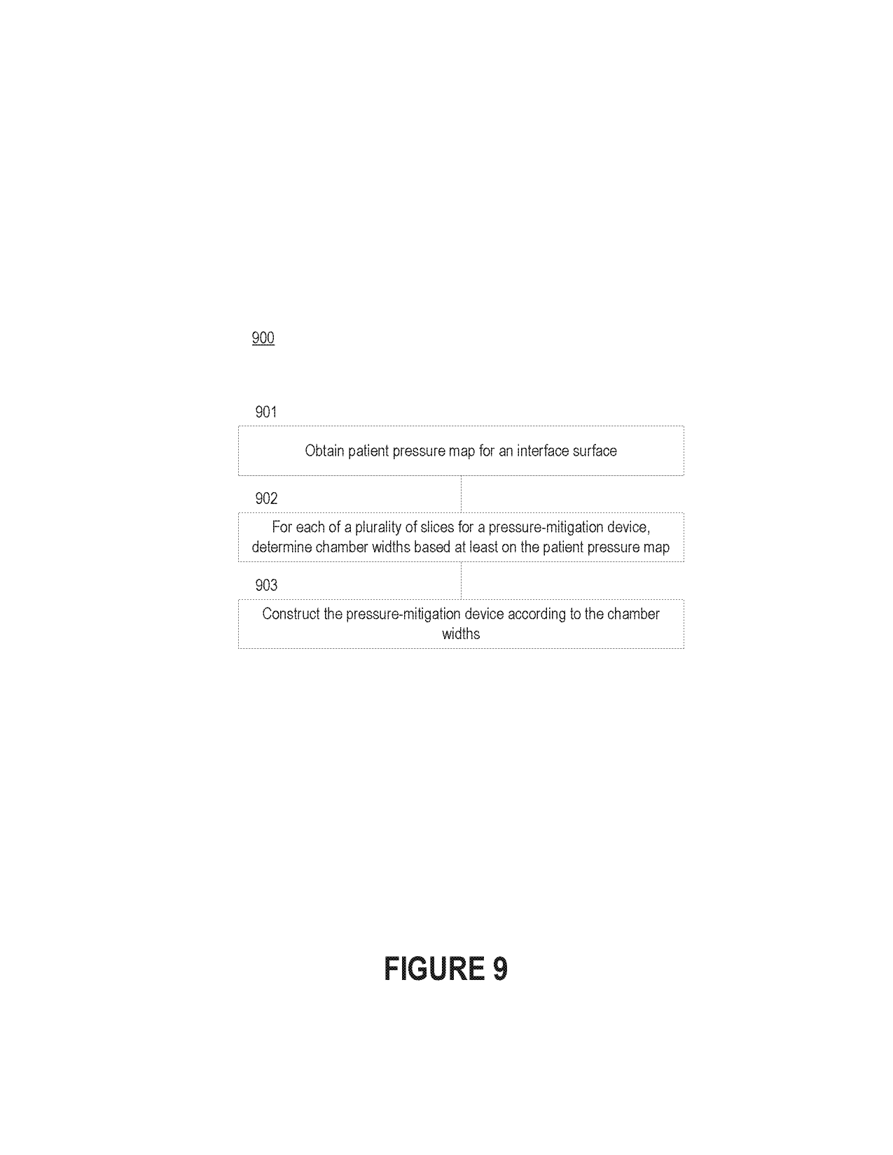

FIG. 9 is a flow diagram of a process 900 for constructing a pressure-mitigation device to optimally deliver pressure-mitigation treatment for a user in accordance with embodiments of the present technology. Via the process 900, the chambers of the pressure-mitigation device can be designed for specific surface topologies and/or for forming microclimate voids interspersed between the chambers.

Initially, an individual can obtain a patient pressure map for an interface surface (block 901). The patient pressure map can include data describing a weight distribution of a patient upon a flat surface. In some examples, the patient pressure map can be obtained via collecting data from pressure sensors while placing the patient at rest upon a surface, such as a calibration surface, another pressure-mitigation device, and/or the like. In some examples, the patient pressure map can be obtained based on scanning a patient’s body and modeling or simulating a weight distribution by the body.

Then, the individual can determine chamber widths along each of a plurality of section slices for a pressure-mitigation device (block 902). The individual determines the chambers widths along a given slice based on a desired surface topology or height profile along the given slice. The desired surface topology can be based on the patient pressure map, specifically to account for points of relatively high pressure. Such high-pressure points exerted by the patient can be accommodated with chambers with lower inflated heights relative to surrounding chambers, such that these high-pressure points are not met with additional counteracting pressure or force when chambers inflate. The individual can then construct the pressure-mitigation device according to the chamber widths along slices of the pressure-mitigation device (block 903).

Example embodiments of the present disclosure further relate to supporting or maintaining a user of a pressure-mitigation device in a static position during dynamic movements of the pressure-mitigation device underneath the user. Existing systems and techniques rely upon actively moving a user to different positions (e.g., turning the user from laying on its back to its side) where the user experiences surface pressure at different portions of their body. Pressure mitigation and user experience has been shown to be improved when the pressure is redistributed (e.g., as described with FIG. 4), rather than when repositioning the user to receive the same pressure in different body positions. By maintaining the user in a static and stable position, for example in a flat plane parallel with a surface of the pressure-mitigation device, therapeutic and physiological benefits are provided to the user. A given point on the user can receive higher quality pressure treatment if the given point does not experience vertical movement and displacement along with that of the chamber(s) underneath. Further, akin to flicking near blood vessels prior to an injection, intermittent pressure or force exerted by a dynamically inflating and deflating chamber against a stable and static part of a user provides beneficial physiological effects including vessel dilation and histamine release.

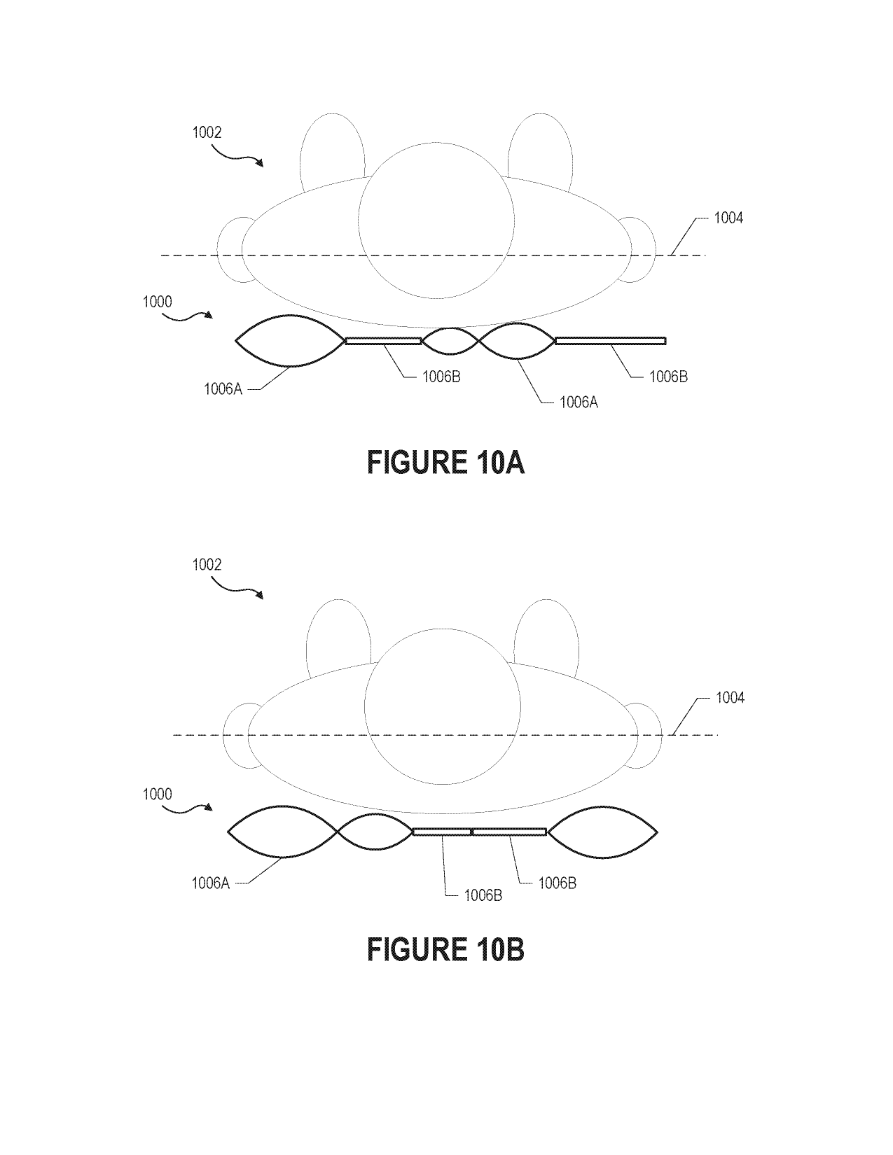

FIGS. 10A and 10B are diagrams that demonstrate a pressure-mitigation device 1000 supporting and maintaining a user 1002 in a static position (e.g., a parallel plane 1004 to the pressure-mitigation device 1000) during dynamic inflation and deflation of the chambers 1006 of the pressure-mitigation device 1000. The parallel plane 1004 can be approximately parallel with a surface of the pressure-mitigation device 1000 (e.g., in its deflated state), or with the elongated object located underneath the pressure-mitigation device 1000. Across FIGS. 10A and 10B, the pressure-mitigation device 1000 includes inflated chambers 1006A and deflated chambers 1006B, and at a given point in time during the operation of the pressure-mitigation device 1000, a given chamber can be an inflated chamber 1006A and a deflated chamber 1006B.

Despite the inflation and deflation of different chambers across the pressure-mitigation device 1000 resulting in different height profiles, the user 1002 remains in its static position within the parallel plane 1004. To an outside observer, it may not be readily apparent that the pressure-mitigation device 1000 is operating below the user 1002 due to the stillness of the user 1002. In some embodiments, a bowl-shaped height profile or surface topology of the pressure-mitigation device 1000 stabilizes the user, as demonstrated in FIG. 10B. For example, larger chambers (e.g., chambers with higher inflatable heights) near the edges of the pressure-mitigation device 1000 can remain inflated while other chambers between the edges are free to dynamically inflate and deflate. That is, in some examples, edge chambers of the pressure-mitigation device 1000 remain inflated. In other examples, a chamber inflation sequence for the pressure-mitigation device 1000 is determined such that, at any given point in time during the sequence, at least some chambers near the edges of the pressure-mitigation device are inflated, thus continuously providing a wide base of support for the user 1002.

The chambers may be selectively inflated and deflated based on positional feedback received during operation of the pressure-mitigation device. In some embodiments, the pressure-mitigation device includes sensors positioned at various points throughout, and a controller for the pressure-mitigation device can receive data from the sensors that describes a weight, pressure, or force exerted by the user at those points. Based on the sensor data, the controller can determine and/or vary an inflation sequence of the chambers of the pressure-mitigation device in order to maintain the user 1002 in the static position. In some embodiments, the controller obtains data from sensors positioned on or attached to the user 1002 itself. For example, an accelerometer, gyroscopic sensor, or the like can be coupled to the user 1002 (e.g., in a wearable device of the user 1002), and the controller uses data obtained from such sensors as feedback for determining or modifying an inflation sequence for the chambers.

In some embodiments, the positional feedback, or feedback describing position or movement of the user disposed atop the pressure-mitigation device, obtained from sensors at various points throughout the pressure-mitigation device can be mapped to a chamber pattern or layout. In doing so, the positional feedback information is actionable by selecting specific chambers in the chamber pattern or layout to inflate or deflate.

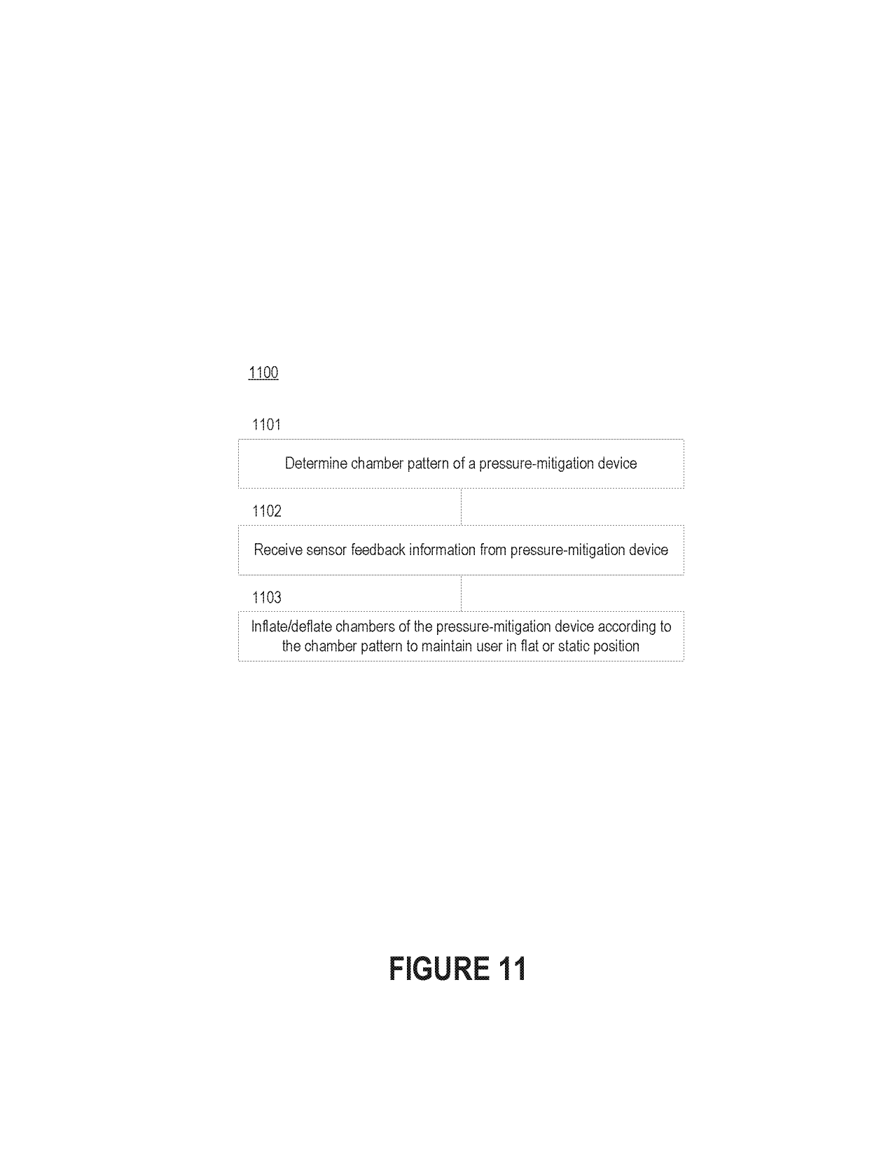

FIG. 11 is a flow diagram of a process 1100 for maintaining a user in a static position during operation of a pressure-mitigation device. By not excessively moving or shaking the user while the pressure-mitigation device delivers its pressure-mitigation treatment, the user experiences improved comfort, additional physiological benefits, and better pressure-mitigation treatment. Further, induced movement or shaking of certain users, such as immobilized users, pediatric patients, users with brain or nervous system injuries, and/or the like, can be undesired or detrimental to the health of such users. In some embodiments, the process 1100 is performed by one or more controllers of the pressure-mitigation device. For example, the one or more controllers include a processor and a memory storing instructions that, when executed by the processor, cause the one or more controllers to perform example operations of the process 1100.

A computing system or a controller of the pressure-mitigation device can determine a chamber pattern of a pressure-mitigation device (step 1101). In some embodiments, a computing system used for pressure-mitigation device construction determines the chamber pattern according to the example operations and process described with FIG. 9; for example, the chamber pattern is determined to minimize an amount of excess material of the pressure-mitigation device, and to be capable to stably maintaining a user of the pressure-mitigation device atop the pressure-mitigation device. In some embodiments, determining the chamber pattern of the pressure-mitigation device includes storing a map of the chamber pattern or layout in a controller; for example, the controller retrieves stored information that describes a chamber layout or pattern of its pressure-mitigation device, and the controller can do so prior to operating the pressure-mitigation device.

The controller can then receive sensor feedback information from the pressure-mitigation device and/or other devices (step 1102). The controller receives the sensor feedback information during operation of the pressure-mitigation device (e.g., while the chambers are being inflated and deflated), and the sensor feedback information can indicate whether or not the user remains in its static position, for example, a flat two-dimensional plane or parallel with a plane of the pressure-mitigation device.

In some embodiments, the controller receives the sensor feedback information from sensors located throughout the pressure-mitigation device and can aggregate or holistically analyze the sensor feedback information from the sensors to determine whether the weight distribution by the user is evenly distributed (thereby indicative that the user is in the flat two-dimensional static position). For example, if the controller determines from the sensor feedback information that the more user weight or pressure is experienced on a left side of the pressure-mitigation device compared to a right side, the sensor feedback information may be indicative of the user being tilted out of a two-dimensional plane or unevenly resting atop the pressure-mitigation device. In some embodiments, the controller additionally obtains pressure maps previously collected for the user to determine inherent uneven weight distributions by the user and the controller can normalize the sensor feedback information to account for the inherent uneven weight distributions by the user.

In some embodiments, the controller receives the sensor feedback information from sensors coupled to the user atop the pressure-mitigation device. For example, the controller is configured to wirelessly communicate with user devices such as a smartphone positioned atop the user, a wearable device, and/or the like. The user devices can include accelerometers, gyroscopes, or similar sensors and can report the sensor feedback information to the controller.

The controller can then selectively inflate and/or deflate chambers of the pressure-mitigation device according to the chamber pattern to maintain the user in a flat and static position (step 1103). The controller inflates/deflates certain chambers that are selected based on the sensor feedback information. For example, if the sensor feedback information indicates that the user is tilting towards a left side of the pressure-mitigation device, the controller can inflate certain chambers located or extending through the left side of the pressure-mitigation device, to bolster the user back to the flat position. In some embodiments, the inflation/deflation of chambers to support the user in the flat position is secondary or additive to the inflation/deflation of chambers to distribute and move around pressure exerted upon the user (e.g., as described with FIG. 4). In one example, the controller can intend to deflate chambers on the left side of the pressure-mitigation device in connection with a chamber inflation/deflation sequence for pressure mitigation, and can determine not to inflate the chambers on the left side despite the sensor feedback information suggesting that the chambers on the left side should be inflated to bolster and support the user in the flat position. In some embodiments, a chamber inflation/deflation sequence for pressure mitigation includes cycles or states in each of which a certain combination of chambers are inflated, and based on the controller determining that the user is moving out of its flat position, the controller can pause and defer the next cycle or state of the chamber inflation/deflation sequence to correct the position of the user. Then, upon the controller determining from the sensor feedback information that the user is back in its flat position, the controller resumes the cycles or states of the chamber inflation/deflation sequence.

### Overview of Controller Devices

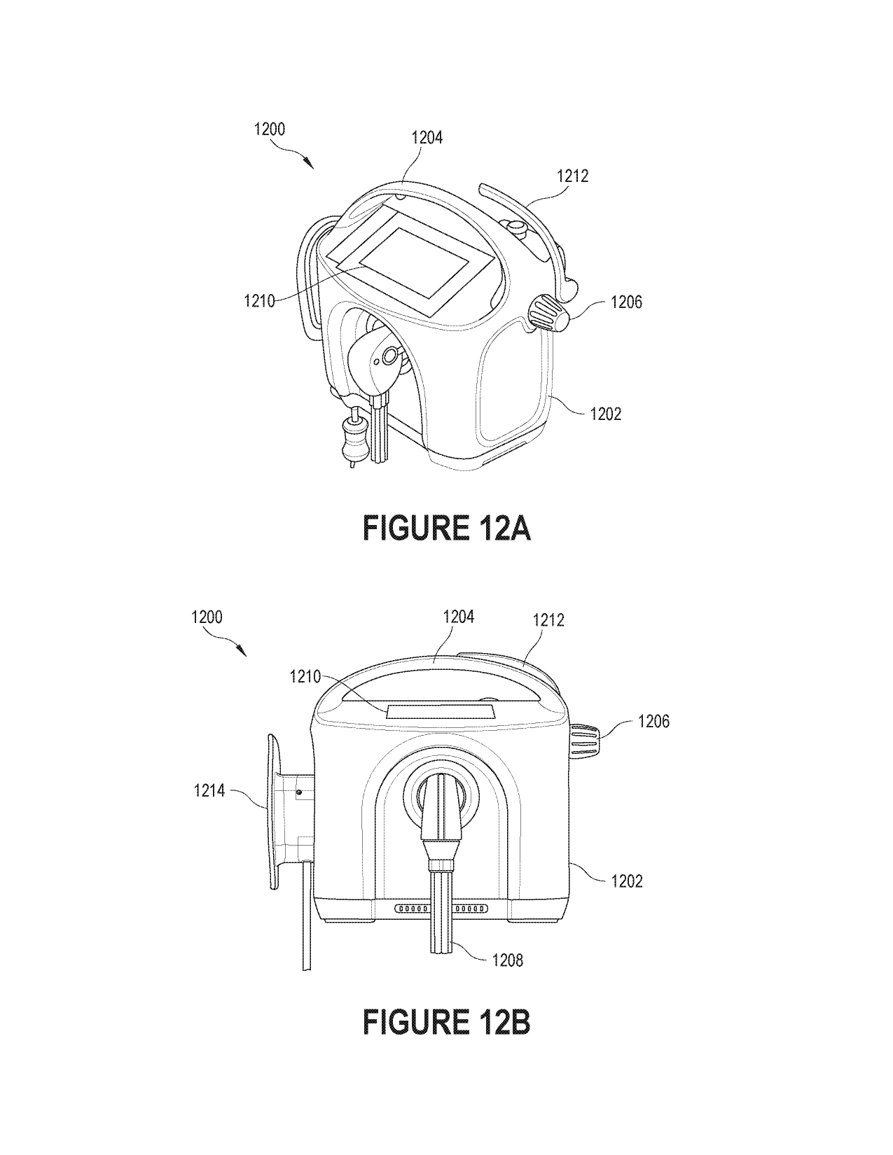

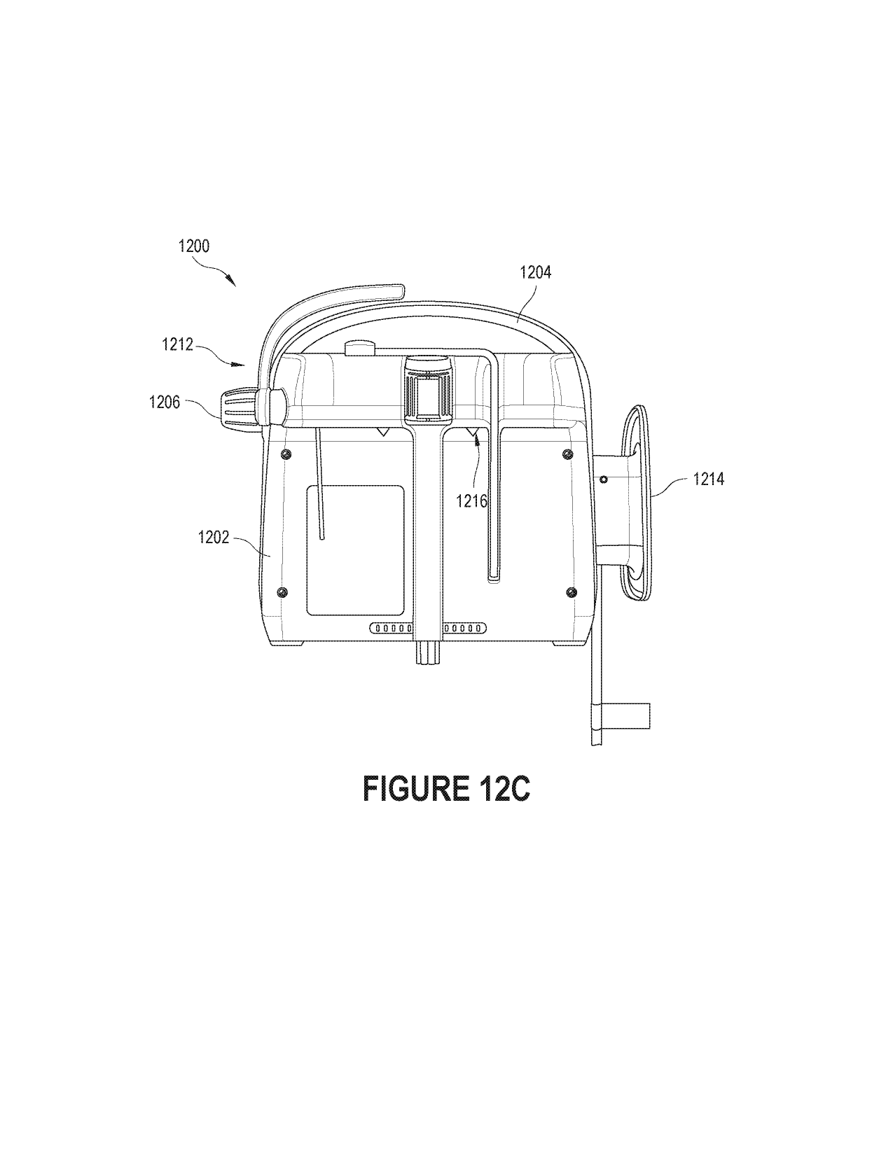

FIGS. 12A-12C are isometric, front, and back views, respectively, of a controller 1200 (also referred to as a “controller device”) that is responsible for controlling inflation and/or deflation of the chambers of pressure-mitigation devices in accordance with embodiments of the present technology. For example, the controller 1200 can be coupled to pressure-mitigation devices to control the pressure within the chambers of the pressure-mitigation devices. The controller 1200 can manage the pressure in each chamber of the pressure-mitigation devices by controllably driving one or more pumps. In some embodiments, a single pump is fluidically connected to all the chambers of the two or more pressure-mitigation devices, such that the pump is responsible for independently directing fluid flow to and/or from multiple chambers. In other embodiments, the controller 1200 is coupled to two or more pumps, each of which can be fluidically coupled to a single chamber to drive inflation/deflation of that chamber. In other embodiments, the controller 1200 is coupled to at least one pump that is fluidically coupled to two or more chambers and/or at least one pump that is fluidically coupled to a single chamber. The pump(s) may reside within the housing of the controller 1200 such that the system is easily transportable. Alternatively, the pump(s) may reside in a housing separate from the controller 1200.

As shown in FIGS. 12A-12C, the controller 1200 can include a housing 1202 in which internal components reside and a handle 1204 that is connected to the housing 1202. In some embodiments the handle 1204 is fixedly secured to the housing 1202 in a predetermined orientation, while in other embodiments the handle 1204 is pivotably secured to the housing 1202. For example, the handle 1204 may be rotatable about a hinge connected to the housing 1202 between multiple positions. The hinge may be one of a pair of hinges connected to the housing 1202 along opposing lateral sides. The handle 1204 enables the controller 1200 to be readily transported, for example, from a storage location to a deployment location (e.g., proximate a human body that is positioned on a surface). Moreover, the handle 1204 could be used to releasably attach the controller 1200 to a structure. For example, the handle 1204 could be hooked on an intravenous (IV) pole (also referred to as an “IV stand” or “infusion stand”).

In some embodiments, the controller 1200 includes a retention mechanism 1214 that is attached to, or integrated within, the housing 1202. Cords (e.g., electrical cords), tubes, and/or other elongated structures associated with the system can be wrapped around or otherwise supported by the retention mechanism 1214. Thus, the retention mechanism 1214 may provide strain relief and retention of an electrical cord (also referred to as a “power cord”). In some embodiments, the retention mechanism 1214 includes a flexible flange that can retain the plug of the electrical cord.

As further shown in FIGS. 12A-12C, the controller 1200 may include a connection mechanism 1212 that allows the housing 1202 to be securely, yet releasably, attached to a structure. Examples of structures include IV poles, mobile workstations (also referred to as “mobile carts”), bedframes, rails, handles (e.g., of wheelchairs), and tables. The connection mechanism 1212 may be used instead of, or in addition to, the handle 1204 for mounting the controller 1200 to the structure. In the illustrated embodiment, the connection mechanism 1212 is a mounting hook that allows for single-hand operation and is adjustable to allow for attachment to mounting surfaces with various thicknesses. In some embodiments, the controller 1200 includes an IV pole clamp 1216 that eases attachment of the controller 1200 to IV poles. The IV pole clamp 1216 may be designed to enable quick securement, and the IV pole clamp 1216 can be self-centering with the use of a single activation mechanism (e.g., knob or button).

In some embodiments, the housing 1202 includes one or more input components 1206 for providing instructions to the controller 1200. The input component(s) 1206 may include knobs (e.g., as shown in FIGS. 12A-12C), dials, buttons, levers, and/or other actuation mechanisms. An operator can interact with the input component(s) 1206 to alter the airflow provided to the two or more pressure-mitigation devices, discharge air from the pressure-mitigation device, or disconnect the controller 1200 from the two or more pressure-mitigation devices (e.g., by disconnecting the controller 1200 from tubing connected between the controller 1200 and the two or more pressure-mitigation devices).

As further discussed below, the controller 1200 can be configured to independently inflate and/or deflate one or more chambers of pressure-mitigation devices in a predetermined pattern specific for each pressure-mitigation device by managing one or more flows of fluid (e.g., air) produced by one or more pumps. In some embodiments the pump(s) reside in the housing 1202 of the controller 1200, while in other embodiments the controller 1200 is fluidically connected to the pump(s). For example, the housing 1202 may include a first fluid interface through which fluid is received from the pump(s) and a second fluid interface through which fluid is directed to the pressure-mitigation devices. Multi-channel tubing may be connected to either of these fluid interfaces. For example, multi-channel tubing may be connected between the first fluid interface of the controller 1200 and multiple pumps. As another example, multi-channel tubing may be connected between the second fluid interface of the controller 1200 and multiple valves of the pressure-mitigation devices. Here, the controller 1200 includes fluid interfaces 1208 designed to interface with multi-channel tubing. In some embodiments the multi-channel tubing permits unidirectional fluid flow, while in other embodiments the multi-channel tubing permits bidirectional fluid flow. Thus, fluid returning from the pressure-mitigation devices (e.g., as part of a discharge process) may travel back to the controller 1200 through the second fluid interface. By controlling the exhaust of fluid returning from the pressure-mitigation devices, the controller 1200 can actively manage the noise created during use.

By monitoring the connections with the fluid interfaces 1208, the controller 1200 may be able to detect which type of pressure-mitigation devices have been connected. Each type of pressure-mitigation device may include a different type of connector. For example, a pressure-mitigation device designed for elongated objects (e.g., the pressure-mitigation device 100 of FIGS. 1A-1B) may include a first arrangement of magnets in its connector, while a pressure-mitigation device designed for non-elongated objects may include a second arrangement of magnets in its connector. The controller 1200 may include one or more sensors arranged near the fluid interfaces 1208 that are able to detect whether magnets are located within a specified proximity. The controller 1200 may automatically determine, based on which magnets have been detected by the sensor(s), which types of pressure-mitigation devices are connected.

Pressure-mitigation devices may have different geometries, layouts, and/or dimensions suitable for various positions (e.g., supine, prone, sitting), various supporting objects (e.g., wheelchair, bed, recliner, surgical table), and/or various user characteristics (e.g., weight, size, ailment), and the controller 1200 can be configured to automatically detect the types of pressure-mitigation devices connected thereto. In some embodiments, the automatic detection is performed using other suitable identification mechanisms, such as the controller 1200 reading a radio-frequency identification (RFID) tag or barcode on the pressure-mitigation devices. Alternatively, the controller 1200 may permit an operator to specify the types of pressure-mitigation devices connected thereto. For example, the operator may be able to select, using an input component (e.g., input component 1206), a type of pressure-mitigation device via a display 1210. The controller 1200 can be configured to dynamically and independently alter the pattern for inflating and/or deflating chambers based on which types of pressure-mitigation devices are connected.

As shown in FIGS. 12A-12B, the controller 1200 may include a display 1210 for displaying information related to the pressure-mitigation devices, the sequence of inflations/deflations, the user, etc. For example, the display 1210 may present an interface that specifies which types of pressure-mitigation devices are connected to the controller 1200. As another example, the display 1210 may present an interface that specifies the programmable pattern/sequence that is presently governing inflation/deflation of the pressure-mitigation devices, as well as the current state within the programmable patterns for each pressure-mitigation device. Other display technologies could also be used to convey information to an operator of the controller 1200. In some embodiments, the controller 1200 includes a series of lights (e.g., light-emitting diodes) that are representative of different statuses to provide visual alerts to the operator or the user. For example, a status light may provide a green visual indication if the controller 1200 is presently providing therapy, a yellow visual indication if the controller 1200 has been paused (i.e., is in a pause mode) (e.g., based on a patient being out of a stable/static flat position atop the device), a red visual indication if the controller 1200 has experienced an issue (e.g., noncompliance of patient, patient not detected) or requires maintenance (i.e., is in an alert mode), etc. These visual indications may dim upon the conclusion of a specified period of time or upon determining that the status has changed (e.g., the pause mode is no longer active).

In some embodiments, the controller 1200 includes a rapid deflate function that allows an operator to rapidly and independently deflate pressure-mitigation devices. The rapid deflate function may be designed such that the entirety of a pressure-mitigation device is deflated or a portion (e.g., the side supports) of the pressure-mitigation device is deflated. This may be a software-implemented solution that can be activated via the display 1210 (e.g., when configured as a touch-enabled interface) and/or input components (e.g., tactile actuators such as buttons, switches, etc.) on the controller 1200. This rapid deflation, in particular the deflation of the side supports, is expected to be beneficial to operators when there is a need for quick access to the user, such as to provide cardiopulmonary resuscitation (CPR).

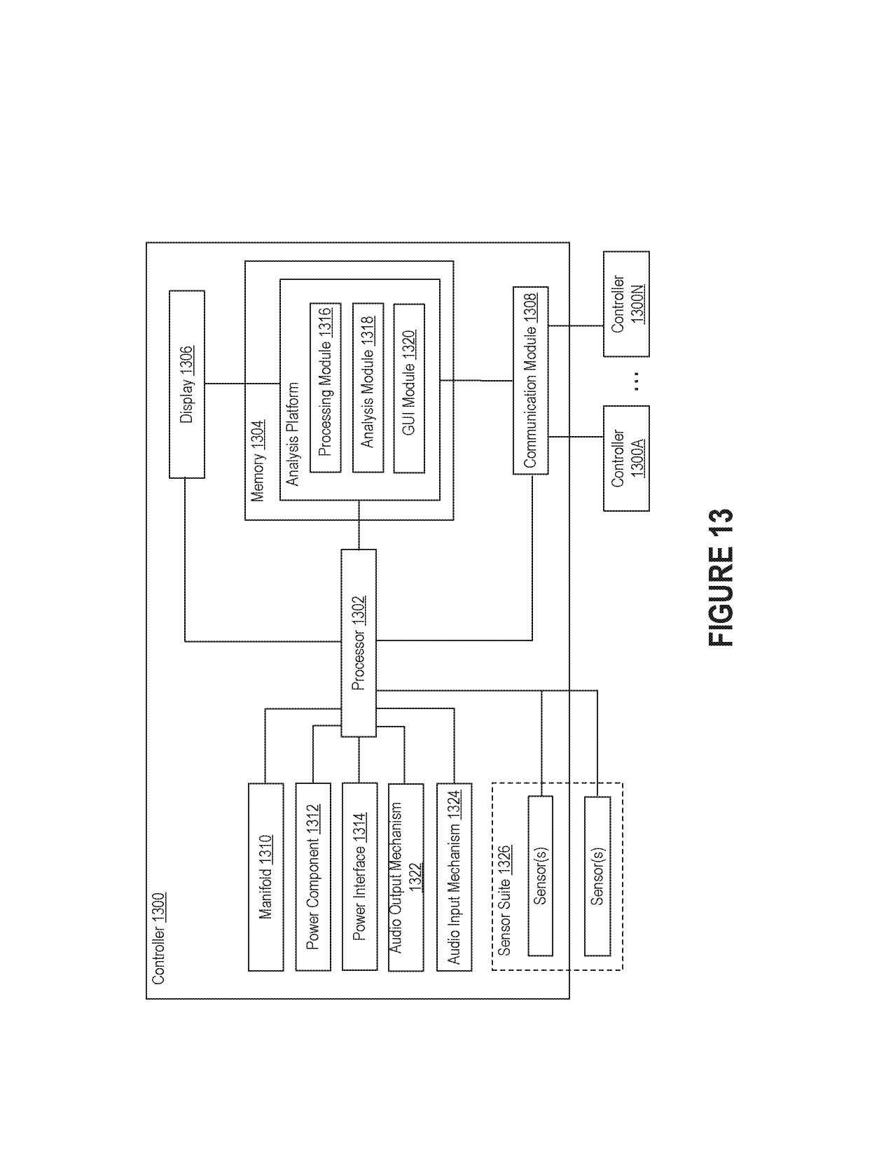

FIG. 13 illustrates an example of a controller 1300 in accordance with embodiments of the present technology. As shown in FIG. 13, the controller 1300 can include a processor 1302, memory 1304, display 1306, communication module 1308, manifold 1310, and/or power component 1312 that is electrically coupled to a power interface 1314. These components may reside within a housing (also referred to as a “structural body”), such as the housing 1302 described above with respect to FIGS. 13A-13C. In some embodiments, the aspects of the controller 1300 are incorporated into other components of a pressure-mitigation system. For example, some components of the controller 1300 may be incorporated into a computing device (e.g., a mobile phone or a mobile workstation) that is remotely coupled to two or more pressure-mitigation devices.

Each of these components is discussed in greater detail below. Those skilled in the art will recognize that different combinations of these components may be present depending on the nature of the controller 1300. Other components could also be included depending on the desired capabilities of the controller 1300.

For example, the controller could include one or more fragrance output mechanisms (e.g., spray pumps or spray nozzles) that are able to discharge scented fluid (e.g., air or liquid) from corresponding reservoirs, so as to produce an aroma. Such a feature may be desirable if one of the two or more pressure-mitigation devices is intended to be used as part of a therapy program.

As another example, the controller could include a circuitry that is able to detect and then examine electronic signatures emitted by nearby beacons. Accordingly, if an item (e.g., a wristband or file) that includes a beacon is presented to the controller, the controller may be able to detect the electronic signature emitted by the beacon and then take appropriate action. For instance, the controller may determine, based on the electronic signature that conveys information regarding the human body to be treated, how to independently inflate each of the chambers of the two or more pressure-mitigation devices. Electronic signatures may be transmitted via RFID, Bluetooth, NFC, or another short-range wireless communication protocol. Additionally or alternatively, the controller may be able to examine machine-readable codes (e.g., Quick Response codes, bar codes, and alphanumeric strings) that are printed on items such as wristbands, files, and the like. By examining the machine-readable code that is printed on an item associated with a human body, the controller may be able to determine, infer, or derive information regarding the human body. These features allow a controller to act as a “single action” solution for treating the human body since the controller may automatically begin treatment after an electronic signature or machine-readable code has been presented.

The processor 1302 can have generic characteristics similar to general-purpose processors, or the processor 1302 may be an application-specific integrated circuit (ASIC) that provides control functions to the controller 1300. As shown in FIG. 13, the processor 1302 can be coupled to all components of the controller 1300, either directly or indirectly, for communication purposes.

The memory 1304 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 1302, the memory 1304 can also store data generated by the processor 1302 (e.g., when executing the analysis platform). Note that the memory 1304 is merely an abstract representation of a storage environment. The memory 1304 could be comprised of actual memory chips or modules.

The display 1306 can be any mechanism that is operable to visually convey information to an operator. For example, the display 1306 may be a panel that includes LEDs, organic LEDs, liquid crystal elements, or electrophoretic elements. Alternatively, the display 1306 may simply be a series of lights (e.g., LEDs) that are able to indicate the status of the controller 1300. In some embodiments, the display 1306 is touch sensitive. Thus, an operator user may be able to provide input to the controller 1300 by interacting with the display 1306 itself. Additionally or alternatively, the operator may be able to provide input to the controller 1300 by interacting with input components, such as knobs, dials, buttons, levers, and/or other actuation mechanisms.

The communication module 1308 may be responsible for managing communications between the components of the controller 1300, or the communication module 1308 may be responsible for managing communications with other computing devices (e.g., a mobile phone associated with the operator, a network-accessible server system accessible to an entity responsible for manufacturing, providing, or managing pressure-mitigation devices, wearable devices of a patient that include sensors). The communication module 1308 may be wireless communication circuitry that is designed to establish communication channels with other computing devices. Examples of wireless communication circuitry include integrated circuits (also referred to as “chips”) configured for Bluetooth®, Wi-Fi®, Near Field Communication (NFC), and the like.

Moreover, the communication module 1308 may be responsible for providing information for uploading to, and retrieving information from, the electronic health record that is associated with the human body that is presently being treated. Assume, for example, that the controller 1300 receives input indicating that a given person is to be treated using two or more pressure-mitigation devices. In such a situation, the controller 1300 may establish a connection with a storage medium that includes the electronic health record of the given person. In some embodiments the controller 1300 downloads information from the electronic health record into the memory 1304, while in other embodiments the controller 1300 simply accesses the information in the electronic health record. This information could be used to determine how to treat the given person. For example, the controller may determine, based on the weight and age of the given person, which patterns to select for inflating each of the chambers of the two or more pressure-mitigation devices, whether and when to adjust the patterns, etc.

The controller 1300 may be connected to pressure-mitigation devices that each includes a series of chambers whose pressure can be individually varied. When each pressure-mitigation device is placed between a human body and the surface of an object, the controller 1300 can independently cause the pressure on an anatomical region of the human body to be varied by controllably inflating and/or deflating chamber(s). Such action can be accomplished by the manifold 1310, which controls the flow of fluid to the series of chambers of each pressure-mitigation device.

Transducers mounted in the manifold 1310 can generate an electrical signal based on the pressure detected in each chamber of each pressure-mitigation device. Generally, each chamber is associated with a different fluid channel and a different transducer. Accordingly, if the manifold 1310 is designed to facilitate the flow of fluid to a pressure-mitigation device with four chambers, the manifold 1310 may include four fluid channels and four transducers. In some embodiments, the manifold 1310 includes fewer than four fluid channels and/or transducers or more than four fluid channels and/or transducers. Pressure data representative of the values of the electrical signals generated by the transducers can be stored, at least temporarily, in the memory 1304. The manifold 1310 may be driven based on a clock signal that is generated by a clock module (not shown). For example, the processor 1302 may be configured to generate signals for driving valves in the manifold 1310 (or driving integrated circuits in communication with the valves) based on a comparison of the clock signal to programmed patterns that indicate when each chamber of the two or more pressure-mitigation devices should be independently inflated or deflated. The programmed patterns may belong to a set of multiple programmed patterns that are stored in the memory 1304.

An analysis platform may be responsible for examining the pressure data. For convenience, the analysis platform is described as a computer program that resides in the memory 1304. However, the analysis platform could be comprised of software, firmware, or hardware that is implemented in, or accessible to, the controller 1300. In accordance with embodiments described herein, the analysis platform may include a processing module 1316, analysis module 1318, and graphical user interface (GUI) module 1320. Each of these modules can be an integral part of the analysis platform. Alternatively, these modules can be logically separate from the analysis platform but operate “alongside” it. Together, these modules enable the analysis platform to gain insights not only into whether the pressure-mitigation device connected to the controller 1300 is being used properly, but also into the health of the human body situation on or in the two or more pressure-mitigation devices.

The processing module 1316 can process pressure data obtained by the analysis platform into a format that is suitable for the other modules. For example, in preparation for analysis by the analysis module 1318, the processing module 1316 may apply algorithms designed for temporal aligning, artifact removal, and the like. Accordingly, the processing module 1316 may be responsible for ensuring that the pressure data is accessible to the other modules of the analysis platform. As further discussed below, the processor 1302 may forward at least some of the pressure data, in either its processed or unprocessed form, to the communication module 1308 for transmittal to a destination for analysis. In such a scenario, the processing module 1316 may apply operations (e.g., filtering, compressing, labelling) to the pressure data before it is forwarded to the communication module 1308 for transmission to the destination.

By examining the pressure data in conjunction with flow data representative of the fluid flowing into the controller 1300 from the pump(s), the analysis module 1318 can control how the chambers of the pressure-mitigation device are inflated and/or deflated. For example, the analysis module 1318 may be responsible for separately and independently controlling the set point for fluid flowing into each chamber such that the pressures of the chambers match a predetermined pattern for each pressure-mitigation device.

By examining the pressure data, the analysis module 1318 may also be able to sense movements of the human body under which each pressure-mitigation device is positioned. These movements may be caused by the user, another individual (e.g., a caregiver or an operator of the controller 1300), or the underlying surface. The analysis module 1318 may apply algorithms to the data representative of these movements (also referred to as “movement data” or “motion data”) to identify repetitive movements and/or random movements to better understand the health state of the user. For example, the analysis module 1318 may be able to produce a coverage metric indicative of the amount of time that the human body is properly positioned on or in each pressure-mitigation device. As further discussed below, the controller 1300 (or another computing device) may be able to independently establish whether each pressure-mitigation device has been properly deployed and/or operated based on the coverage metric. As another example, the analysis module 1318 may be able to establish the respiration rate, heart rate, or another vital measurement based on the movements of the user. Generally, the movement data are derived from the pressure data. That is, the analysis module 1318 may be able to infer movements of the human body by analyzing the pressure of the chambers of each of the pressure-mitigation devices in conjunction with the rate at which fluid is being delivered to those chambers. Consequently, some embodiments of each of the pressure-mitigation devices may not actually include any sensors for measuring movement, such as accelerometers, tilt sensors, or gyroscopes.

The analysis module 1318 may respond in several ways after examining the pressure data. For example, the analysis module 1318 may generate a notification (e.g., an alert) to be transmitted to another computing device by the communication module 1308. The other computing device may be associated with a medical professional (e.g., a physician or a nurse), a caregiver (e.g., a family member or friend of the user), or some other entity (e.g., a researcher or an insurer). As another example, the analysis module 1318 may cause the pressure data (or analyses of such data) to be integrated with the electronic health record of the user. Generally, the electronic health record is maintained in a storage medium that is accessible to the communication module 1308 across a network.

The GUI module 1320 may be responsible for generating interfaces that can be presented on the display 1306. Various types of information can be presented on these interfaces. For example, information that is calculated, derived, or otherwise obtained by the analysis module 1318 may be presented on an interface for display to the user or operator. As another example, visual feedback may be presented on an interface so as to indicate whether the user is properly situated on or in each pressure-mitigation device.

The controller 1300 may include a power component 1312 that is able to provide to the other components residing within the housing, as necessary. Examples of power components include rechargeable lithium-ion (Li-Ion) batteries, rechargeable nickel-metal hydride (NiMH) batteries, rechargeable nickel-cadmium (NiCad) batteries, etc. In some embodiments, the controller 1300 does not include a power component, and thus must receive power from an external source. In such embodiments, a cable designed to facilitate the transmission of power (e.g., via a physical connection of electrical contacts) may be connected between the power interface 1314 of the controller 1300 and the external source. The external source may be, for example, an alternating current (AC) power socket or another computing device. The cable connected to the power interface 1314 of the controller 1300 may also be able to convey power so as to recharge the power component 1312.

Embodiments of the controller 1300 can include any subset of the components shown in FIG. 13, as well as additional components not illustrated here.

For example, while the controller 1300 is able to receive and transmit data wirelessly via the communication module 1308, other embodiments of the controller 1300 may include a physical data interface through which data can be transmitted to another computing device. Examples of physical data interfaces include Ethernet ports, Universal Serial Bus (USB) ports, and proprietary ports.

As another example, some embodiments of the controller 1300 include an audio output mechanism 1322 and/or an audio input mechanism 1324. The audio output mechanism 1322 may be any apparatus that is able to convert electrical impulses into sound. One example of an audio output mechanism is a loudspeaker (or simply “speaker”). Meanwhile, the audio input mechanism 1324 may be any apparatus that is able to convert sound into electrical impulses. One example of an audio input mechanism is a microphone. Together, the audio output and input mechanisms 1322, 1324 may enable the user or operator to engage in an audible exchange with a person who is not located proximate the controller 1300. Assume, for example, that the user has become misaligned with one or more of the two or more pressure-mitigation devices. In such a scenario, the user may utilize the audio input mechanism 1324 to verbally ask for assistance, for example, from another person who is able to verbally confirm that assistance is forthcoming using the audio output mechanism 1322. The other person could be a medical professional or caretaker of the user. This may be useful in situations where the user is unable to reposition herself on or in one of the pressure-mitigation devices due to an underlying condition that inhibits or prevents movement.

The audio input mechanism 1324 may also be able to generate a signal that is indicative of more nuanced sounds. For example, the audio input mechanism 1324 may generate data that is representative of sounds originating from within the human body situated on or in one or more of the two or more pressure-mitigation devices. These sounds may be representative of auscultation sounds generated by the circulatory, respiratory, and gastrointestinal systems. These data could be transmitted (e.g., by the communication module 1308) to a destination for analysis.

Other sensors may also be implemented in, or accessible to, the controller 1300. For example, sensors may be contained in the housing of the controller 1300 and/or embedded within each pressure-mitigation device that is connected to the controller 1300. Collectively, these sensors may be referred to as the “sensor suite” 1326. For example, the sensor suite 1326 may include a motion sensor whose output is indicative of motion of the controller 1300 or each pressure-mitigation device. Examples of motion sensors include multi-axis accelerometers and gyroscopes. As another example, the sensor suite 1326 may include a proximity sensor whose output is indicative of proximity to the controller 1300 or pressure-mitigation device. A proximity sensor may include, for example, an emitter that is able to emit infrared (IR) light and a detector that is able to detect reflected IR light that is returned toward the proximity sensor. These types of proximity sensors are sometimes called laser imaging, detection, and ranging (LiDAR) scanners. Other examples of sensors include an ambient light sensor whose output is indicative of the amount of light in the ambient environment, a temperature sensor whose output is indicative of the temperature of the ambient environment, and a humidity sensor whose output is indicative of the humidity of the ambient environment. The output(s) produced by the sensor suite 1326 may provide greater insight into the environment in which the controller 1300 is deployed (and thus the environment in which the human body situated on or in each of the two or more pressure-mitigation devices is to be treated).

In some embodiments, the sensor suite 1326 includes one or more specialty sensors that are designed to generate, obtain, or otherwise produce information related to the health of the human body. For example, the sensor suite 1326 may include a vascular scanner. The term “vascular scanner” may be used to refer to an imaging instrument that includes (i) an emitter operable to emit electromagnetic radiation (e.g., in the near infrared range) into the body and (ii) a sensor operable to sense electromagnetic radiation reflected by physiological structures inside the human body. Normally, an image is created based on the reflected electromagnetic radiation that serves as a reference template for the vasculature of an anatomical region. Thus, the vasculature in an anatomical region could be periodically or continually monitored based on outputs produced by a vascular scanner included in the sensor suite 1326. Additionally or alternatively, the sensor suite 1326 may include sensors that are designed to perform pulse oximetry by determining oxygen level of the blood, measure blood pressure, compute heartrate, etc.

Based on the output(s) produced by the sensor suite 1326, the controller 1300 (or some other computing device) may be able to compute some or all of the main vital signs, namely, body temperature, blood pressure, pulse rate, and breathing rate (also referred to as “respiratory rate”). Moreover, the controller 1300 (or some other computing device) may be able to compute metrics that are indicative of the health of the human body, despite not being one of the main vital signs. For example, output(s) generated by the sensor suite 1326 could be used to establish whether the human body is performing a given activity (e.g., sleeping or eating). The output(s) could be used to not only ascertain the sleep pattern of the human body, but also whether changes in the sleep pattern indicate whether the health state of the human body has improved (e.g., sleep more consistent with longer duration following deployment of each pressure-mitigation device).

Note that the sensors included in the sensor suite 1326 need not necessarily be included in the controller 1300. For example, the controller 1300 may be communicatively connected to ancillary sensors that are included in various items (e.g., blankets and clothing), attached to the human body, etc.

These various components may allow the controller 1300 to be readily integrated into a network-connected environment, such as a home or hospital. Thus, the controller 1300 may be communicatively coupled to mobile phones, tablet computers, wearable electronic devices (e.g., fitness trackers and watches), or network-connected devices (also referred to as “smart devices”), such as televisions and home assistant devices. Similarly, the controller 1300 may be communicatively coupled to medical devices, such as cardiac pacemakers, insulin pumps, glucose monitoring devices, and the like. This level of integration can provide several notable benefits over conventional technologies for mitigating pressure.

As an example, the pressure-mitigation system of which the controller 1300 is a part may be used to monitor health of a human body in a more holistic sense. As mentioned above, insights into movements of the human body can be surfaced through analysis of pressure data generated by the controller 1300 or pressure-mitigation devices. Analysis of these movements over an extended period of time (e.g., days, weeks, or months) may lead to the discovery of abnormalities that might otherwise go unnoticed. For example, the controller 1300 (or some other computing device) may infer that the human body is suffering from an ailment in response to a determination that its movements over a recent interval of time differ from those that would be expected based on past intervals of time. At a high level, insights gained through analysis of the pressure data can be used not only to define a “health baseline” for the human body, but also to discover when deviations from the health baseline occur.

As another example, the controller 1300 may be responsible for providing or supplementing prompts to administer medication in accordance with a regimen. Assume, for example, that a user positioned on or in one or more of the two or more pressure-mitigation devices is associated with a regimen that requires a medication be administered regularly. The controller 1300 may promote adherence to the regimen by prompting the user or another person (e.g., an operator of the controller 1300) to administer the medication. Visual notifications could be presented by the display 1306, or audible notifications could be presented by the audio output mechanism 1322. Additionally or alternatively, the controller 1300 could cause digital notifications (also referred to as “electronic notifications”) to be presented by a computing device that is communicatively coupled to the controller 1300. In some embodiments, the regimen is stored in the memory 1304 of the controller 1300. In other embodiments, the regimen is stored in the memory of a computing device that is communicatively coupled to the controller 1300. For example, the regimen may be implemented by a computer program that is executing on a mobile device associated with the user, and when the computer program determines that a dose of the medication is due to be administered, the computer program may transmit an instruction to the controller 1300 to generate a notification.

As another example, the controller 1300 may be able to facilitate communication with medical professionals. Assume, for example, that the controller 1300 is deployed in a home environment that medical professionals visit infrequently or not at all. In such a scenario, the controller 1300 may allow the user to communicate with medical professionals who are located outside of the home environment. Thus, the user may be able to communicate, via the audio output and input mechanisms 1322, 1324, with medical professionals who are located in a hospital environment (e.g., at which the user received treatment) or their own home environments.

As another example, the controller 1300 may be able to facilitate communication with emergency services. For instance, if the controller 1300 determines (e.g., through analysis of pressure data) that no movement has occurred for a predetermined amount of time, the controller 1300 may prompt the user to respond. Similarly, if the controller 1300 receives input from the user indicative of a request for assistance, the controller 1300 may initiate communication with emergency services. Thus, the controller 1300 may be programmed to person some action if, for example, it determines (e.g., through analysis of the signal generated by the audio input mechanism 1324) that the user has indicated she has fallen or has experienced a medical event (e.g., shortness of breath, heart palpitations, excessing sweating).

These benefits allow pressure-mitigation systems to be deployed in situations where frequent visits by medical professionals may not be practical or possible. For example, when deployed in a hospital environment, a pressure-mitigation system may allow medical professionals to visit patients less frequently. Patients situated on or in two or more pressure-mitigation devices may not need to be turned to alleviate pressure as often, and medical professionals may not need to continually check on patients if pressure-mitigation systems are able to autonomously discover changes in health. As another example, when deployed in a home environment, a pressure-mitigation system may be able to counter a lack of visits from medical professionals. If a patient is instructed to situate herself on or in one or more of two or more pressure-mitigation devices while at home, the patient may only need to be visited every few (e.g., three, five, or seven) days rather than once per day or multiple times per day. Overall, implementing pressure-mitigation systems can lead to significant cost savings because medical professionals are required to make less frequent visits and perform fewer medical procedures, and because patients can be discharged more quickly.

The controller 1300 may also be designed to focus on wellness in addition to, or instead of, treatment for (and prevention of) pressure-induced injuries. As an example, embodiments of the controller 1300 may be designed to aid in sleep management, for healthy individuals and/or unhealthy individuals. Using the audio output mechanism 1322 in combination with the manifold 1310, the controller 1300 may be able to accomplish tasks such as simulating the presence of another person, for example, by producing vocal sounds, breathing sounds, applying pressure, and the like.

### Example Processing Systems

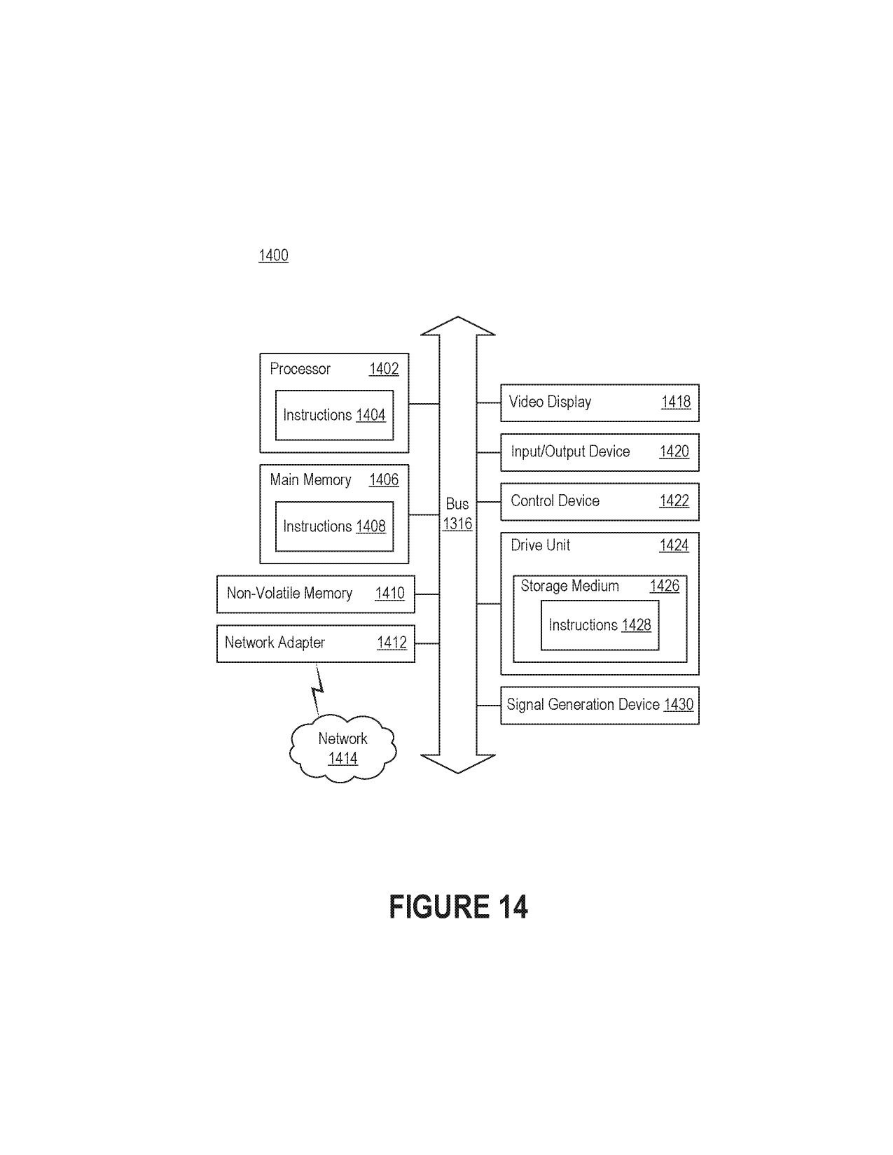

FIG. 14 is a block diagram illustrating an example of a processing system 1400 in which at least some operations described herein can be implemented. For example, components of the processing system 1400 may be hosted on a controller responsible for controlling the flow of fluid to each pressure-mitigation device. As another example, components of the processing system 1400 may be hosted on a computing device that is communicatively coupled to the controller.

The processing system 1400 may include a processor 1402, main memory 1406, non-volatile memory 1410, network adapter 1412 (e.g., a network interface), video display 1418, input/output device 1420, control device 1422 (e.g., a keyboard, pointing device, or mechanical input such as a button), drive unit 1424 that includes a storage medium 1426, or signal generation device 1430 that are communicatively connected to a bus 1416. The bus 1416 is illustrated as an abstraction that represents one or more physical buses and/or point-to-point connections that are connected by appropriate bridges, adapters, or controllers. The bus 1416, therefore, can include a system bus, Peripheral Component Interconnect (PCI) bus, PCI-Express bus, HyperTransport bus, Industry Standard Architecture (ISA) bus, Small Computer System Interface (SCSI) bus, Universal Serial Bus (USB), Inter-Integrated Circuit (I²C) bus, or bus compliant with Institute of Electrical and Electronics Engineers (IEEE) Standard 1494.

The processing system 1400 may share a similar computer processor architecture as that of a computer server, router, desktop computer, tablet computer, mobile phone, video game console, wearable electronic device (e.g., a watch or fitness tracker), network-connected (“smart”) device (e.g., a television or home assistant device), augmented or virtual reality system (e.g., a head-mounted display), or another computing device capable of executing a set of instructions (sequential or otherwise) that specify action(s) to be taken by the processing system 1400.

While the main memory 1406, non-volatile memory 1410, and storage medium 1426 are shown to be a single medium, the terms “storage medium” and “machine-readable medium” should be taken to include a single medium or multiple media that stores one or more sets of instructions 1428. The terms “storage medium” and “machine-readable medium” should also be taken to include any medium that is capable of storing, encoding, or carrying a set of instructions for execution by the processing system 1400.

In general, the routines executed to implement the embodiments of the present disclosure may be implemented as part of an operating system or a specific application, component, program, object, module, or sequence of instructions (collectively referred to as “computer programs”). The computer programs typically comprise one or more instructions (e.g., instructions 1404, 1408, 1428) set at various times in various memories and storage devices in a computing device. When read and executed by the processor 1402, the instructions cause the processing system 1400 to perform operations to execute various aspects of the present disclosure.

While embodiments have been described in the context of fully functioning computing devices, those skilled in the art will appreciate that the various embodiments are capable of being distributed as a program product in a variety of forms. The present disclosure applies regardless of the particular type of machine- or computer-readable medium used to actually cause the distribution. Further examples of machine- and computer-readable media include recordable-type media such as volatile and non-volatile memory devices 1410, removable disks, hard disk drives, optical disks (e.g., Compact Disk Read-Only Memory (CD-ROMS) and Digital Versatile Disks (DVDs)), cloud-based storage, and transmission-type media such as digital and analog communication links.

The network adapter 1412 enables the processing system 1400 to mediate data in a network 1414 with an entity that is external to the processing system 1400 through any communication protocol supported by the processing system 1400 and the external entity. The network adapter 1412 can include a network adaptor card, a wireless network interface card, a switch, a protocol converter, a gateway, a bridge, a hub, a receiver, a repeater, or a transceiver that includes an integrated circuit (e.g., enabling communication over Bluetooth or Wi-Fi).

The techniques introduced here can be implemented using software, firmware, hardware, or a combination of such forms. For example, aspects of the present disclosure may be implemented using special-purpose hardwired (i.e., non-programmable) circuitry in the form of application-specific integrated circuits (ASICs), programmable logic devices (PLDs), field-programmable gate arrays (FPGAs), and the like.

### Remarks

The foregoing description of various embodiments has been provided for the purposes of illustration and description. It is not intended to be exhaustive or to limit the disclosed subject matter to the precise forms disclosed. Many modifications and variations will be apparent to one skilled in the art. Embodiments were chosen and described in order to best describe the principles of the invention and its practical applications, thereby enabling those skilled in the relevant art to understand the disclosed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the patent document has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

1. A method of constructing a pressure-mitigation device, the method comprising:
laying a second layer atop a first layer, such that the first and second layers are parallel and together define a deflated state of the pressure-mitigation device in which the pressure-mitigation device is substantially flat across a top surface and a bottom surface simultaneously;
determining, within a section slice along a length or a width of the pressure-mitigation device, locations at which interconnections between the first layer and the second layer are to be formed to define chambers of the pressure-mitigation device;
forming the interconnections at the locations for a plurality of section slices while the pressure-mitigation device is in the deflated state, so as to define a chamber layout that spans across the length and the width of the pressure-mitigation device; and
providing the pressure-mitigation device for operation, during which the chambers are controllably inflated to varying amounts to bring the pressure-mitigation device into an inflated state in which the pressure-mitigation device is not substantially flat across the top surface or the bottom surface.

2. The method of claim 1, wherein determining the locations comprises spacing two adjacent interconnections within the section slice such that a chamber defined between the two adjacent interconnections is configured to inflate to a desired height.

3. The method of claim 2, wherein the locations at which the interconnections are formed define, within the section slice, the chambers with varying widths such that an inflation of each of the chambers forms a bowl-shape height profile across the section slice that centers a user disposed atop the pressure-mitigation device.

4. The method of claim 2, wherein a distance within the section slice between two adjacent locations at which the interconnections are formed is determined is based on an elasticity of at least one of the first layer or the second layer.

5. The method of claim 1, wherein the operation during which the chambers are controllably inflated comprises:
causing a microclimate void to be formed between two adjacent chambers of the two-dimensional chamber layout, the microclimate void delivering cooling and desiccating effects to an object disposed atop the two adjacent chambers.

6. The method of claim 5, wherein the locations at which interconnections are formed are determined based on desired sizes of microclimate voids across the length and the width of the pressure-mitigation device.

7. The method of claim 5, wherein the first layer and the second layer are both formed of material that is impermeable to a fluid used to inflate the chambers of the pressure-mitigation device.

8. The method of claim 1, further comprising:
determining a shape of each chamber within the two-dimensional chamber layout, wherein the shape of each chamber is used to determine a number of locations at which interconnections are formed within a given section slice.

9. The method of claim 1, wherein the interconnections fully intertwine the first layer with the second layer.

10. The method of claim 1, wherein the interconnections are vertical walls that span the minimal height between first layer and second layer.

11. The method of claim 10, wherein providing the pressure-mitigation device for operation includes maintaining a minimum fluid pressure within the chambers of the pressure-mitigation device such that the vertical walls are kept extended without collapsing.

12. The method of claim 1, wherein the locations within a section slice are determined based on a weight-distribution by one or more users with respect to the section slice.

13. A pressure-mitigation device comprising:
a plurality of chambers that are independently inflatable and are defined via interconnections between a first layer and a second layer,
wherein the plurality of chambers are defined while the pressure-mitigation device is in a deflated state, with the first layer being parallel to the second layer, and
wherein when the plurality of chambers are inflated, the pressure-mitigation device enters an inflated state in which the first layer is no longer parallel to the second layer.

14. The pressure-mitigation device of claim 13, wherein each of the plurality of inflatable chambers are sized with respect to a length or a width of the pressure-mitigation device based on the interconnections being formed at certain locations along a section slice of the pressure-mitigation device.

15. The pressure-mitigation device of claim 14, wherein the plurality of inflatable chambers are sized based on a weight distribution of a user along the section slice of the pressure-mitigation device.

16. The pressure-mitigation device of claim 13, wherein the plurality of inflatable chambers when inflated form a bowl-shaped top surface of the pressure-mitigation device that centers a user atop the pressure-mitigation device.

17. The pressure-mitigation device of claim 13, further comprising:
microclimate voids that are each formed between two adjacent inflatable chambers that are inflated and a surface of an object disposed atop the pressure-mitigation device, the microclimate voids delivering cooling and desiccating effects to the surface of the object.

18. The pressure-mitigation device of claim 13, wherein the first layer and the second layer are both formed of material that is impermeable to a fluid used to inflate the inflatable chambers.

19. The pressure-mitigation device of claim 13, wherein the interconnections fully intertwine the first layer with the second layer.

20. The pressure-mitigation device of claim 13, wherein the interconnections are vertical walls that span between the first layer and the second layer.

21. A controller for operating a pressure-mitigation device, the controller comprising:
a processor; and
a memory storing instructions that, when executed by the processor, cause the controller to:
while a subject is disposed atop the pressure-mitigation device, receive a signal from a sensor that indicates a rotational position of the subject relative to a two-dimensional plane corresponding to a top surface of the pressure-mitigation device while the pressure-mitigation device is in a deflated state; and
determine, based on the signal, how to inflate chambers of the pressure-mitigation device to bolster the subject to a flat rotational position that is parallel with the two-dimensional plane; and
cause the chambers to be inflated to bolster the subject to the flat rotational position.

22. The controller of claim 21, wherein the signal is received from one or more pressure sensors included in the pressure-mitigation device that are configured to measure a force exerted by a subject at corresponding points throughout the pressure-mitigation device.

23. The controller of claim 21, wherein the signal is received from one or more wearable devices attached to the subject and communicably coupled with the controller, wherein the one or more wearable devices include a gyroscope.

24. The controller of claim 21, wherein the instructions further cause the controller to:
while causing the chambers to be inflated to bolster the subject, pause a pre-determined inflation sequence for the chambers to create moving pressure gradients on the subject.
